(19) United States
(12) Patent Application Publication
(10) Pub. No.: US 2021/0371291 A1
(43) Pub. Date: Dec. 2, 2021

(54) HYDROPHOBIC ZEOLITES WITH LOW SILANOL DENSITIES

(71) Applicant: The Board of Trustees of the University of Illinois, Urbana, IL (US)

(72) Inventors: David William FLAHERTY, Urbana, IL (US); Daniel Bregante, Urbana, IL (US)

(73) Assignee: The Board of Trustees of the University of Illinois, Urbana, IL (US)

(21) Appl. No.: 17/326,012

(22) Filed: May 20, 2021

Related U.S. Application Data
(60) Provisional application No. 63/032,320, filed on May 29, 2020.

(51) Int. Cl. C01B 39/46

(52) U.S. Cl. CPC C01B 39/46

(57) ABSTRACT

A method for the synthesis of siliceous or heteroatom-substituted MFI zeolites (M-MFI; M=Si, Ti, Nb, or Ta) with tunable densities of SiOH that depend simply on the ratio of hydrofluoric acid (HF) to structure-directing agent (SDA; tetrapropylammonium hydroxide) used within the synthesis gel. The equilibrated ion exchange between OH⁻ and F⁻ ions forms tetrapropylammonium fluoride in situ, which does not lead to the formation of SiOH defects within M-MFI. Comparisons of infrared spectra from 15 distinct M-MFI materials show that the densities of SiOH groups within M-MFI decrease linearly with the ratio of HF:SDA, independent of the identity of the heteroatom within the framework.

### RELATED APPLICATIONS

This application claims priority under 35 U.S.C. § 119(e) to U.S. Provisional Patent Application No. 63/032,320, filed May 29, 2020, which is incorporated herein by reference.

### GOVERNMENT SUPPORT

This invention was made with government support under Grant No. DE-SC0020224 awarded by the Department of Energy. The government has certain rights in the invention.

### BACKGROUND OF THE INVENTION

The concept of differentiating molecules by their size and shape drives the development of zeolite and zeotype materials for catalysis and adsorption. The sub-nanometer sized pores of these materials can stabilize adsorbates or transition states through interactions between the guest molecules and the confining voids. Van der Waals interactions among reactive species and pore walls provide the most significant differences in the free energies of adsorption and activation when pores are largely vacant. Experiments and simulations show that both polar and non-polar surface functions interact with reactive intermediates through outer-sphere interactions within solvent-filled pores (e.g., depending on solvent structure and reorganization), in ways that are distinct from dispersive interactions between surface intermediates and pore walls often invoked for gas-phase catalysis. Consequently, the controlled functionalization of micropores to control the composition and structure of solvent molecules near active sites is an attractive method to direct the chemical interactions among adsorbates, polar surfaces, and solvent structures.

The role of silanol density, commonly described as hydrophobic or hydrophilic effects, on catalysis and separations in zeolites has been an extensive area of research for decades. For example, H⁺-form Al-substituted silicalite-1 (H⁺—Al-MFI) synthesized in OH⁻ media adsorbs 4-times as much H₂O as hydrophobic materials crystallized in F⁻ media. The uptake of ethanol, however, does not change with the density of SiOH within these materials, which suggests that specific hydrogen-bonding interactions among SiOH and H₂O molecules provide a basis to selectively separate components of aqueous solutions of ethanol. In contrast, Tsapatsis and Siepmann (AlChE J. 2020, 66, e16868) have recently shown that siliceous silicalite-1 (Si-MFI) synthesized in OH⁻ media adsorbs 33% more ethanol than hydrophobic materials synthesized with an equimolar amount of ammonium fluoride (NH₄F) to tetrapropylammonium bromide. Similarly, Si-MFI synthesized in OH⁻ media adsorbs 10-25 times more diol (1,2-butanediol, propylene diol, and ethylene glycol) than hydrophobic Si-MFI synthesized in F⁻ media, which was attributed to hydrogen bonding interactions among silanol defects and the diol adsorbates. The comparisons among these investigations suggest that polar functions (e.g., SiOH in Si-MFI, Brønsted acid sites in H⁺—Al-MFI) within the MFI framework can form stabilizing hydrogen bonds with adsorbates, and the number and strength of these bonds depends upon the hydrogen bond donor-acceptor number of the adsorbate. These results also imply that the strengths of these interactions depend upon the density of SiOH within the zeolite pores.

Metal atoms substituted into zeolite frameworks can also stabilize specific solvent structures. For example, Bukowski et al. (Angew. Chem. Int. Ed. 2019, 58, 16422) have recently used ab initio molecular dynamics to show that interactions between H₂O and Lewis acidic Sn atoms within BEA stabilize small H₂O clusters that comprise 5-6 H₂O molecules. In comparison, H⁺ sites within H⁺—Al-MFI stabilize 8 H₂O molecules within liquid H₂O that has been identified as a hydronium cation surrounded by a 7-membered solvation shell. As such, it is important to consider changes in solvent composition and structure that is due to heteroatoms within the framework, in addition to changes that result from nearby SiOH groups.

Interactions among SiOH functions, reactive species, metal active sites, and H₂O influence the rates and selectivities for methanol-to-hydrocarbons (MTH), alkene epoxidations, glucose isomerization, alcohol dehydration, and Baeyer-Villiger (BV) oxidation reactions in heteroatom substituted zeolites. For example, the initial conversion of methanol is noticeably greater within H⁺—Al-MFI synthesized within F⁻ media than within OH⁻ media during MTH catalysis, purportedly because SiOH defects stabilize H₂O that form as a byproduct, which compete for active sites. Moreover, H⁺—Al-MFI synthesized in F⁻ media deactivates much more slowly than materials synthesized in OH⁻ media, because SiOH defects stabilize aromatic precursors to coke. In the context of alkene epoxidation, Ti-BEA that contain significant densities of SiOH defects stabilize H₂O clusters near active sites that must reorganize upon the formation of epoxidation transition states. The reorganization of these solvent structures leads to large increases in the excess entropy of the transition states and results in rates of epoxidation that increase by a factor of 100 between hydrophobic Ti-BEA relative to materials that contain nearly 5 silanol nests per unit cell. Hydrophobic Ti- and Sn-BEA catalyze the aqueous-phase isomerization of glucose with rates that are 5-50 times greater than their hydrophilic analogues. The presence of H₂O that is localized at or near Ti and Sn atoms within hydrophilic materials compete for active sites and form hydrogen-bonded structures with glucose molecules that greatly decrease the entropy of the transition states. Rates for BV oxidation of cyclohexanone with H₂O₂ are 5-times greater on hydrophilic Sn-BEA (synthesized through post-synthetic modification) than hydrophobic Sn-BEA, which was attributed to stabilizing interactions between the hydrophilic surfaces and the ketone reactant. In general, water and other protic molecules form intricate structures within zeolites through hydrogen-bonds with the surrounding pore walls that impact the stability of adsorbates, intrapore diffusion coefficients, and surface reactions.

Consequently, the hydrophilic nature of a zeolite affects the catalytic performance of a material. Therefore, zeolites that have fewer silanol defects can provide new catalysts that would advance chemical technology.

### SUMMARY

This disclosure provides the hydrothermal synthesis of siliceous and heteroatom-incorporated MFI zeolites (M-MFI; where M represents Si, Ti, Nb, and Ta) with control over the density of SiOH functions. MFI materials are synthesized using tetrapropylammonium hydroxide (TPAOH) and varying amounts of HF (HF:TPAOH ratios from 0-2) to control the density of SiOH groups. Transmission infrared spectra of dehydrated materials show that the relative density of SiOH functions decreases by ˜66% when the HF:SDA ratio increases from 0 to 1. M-MFI with nearly undetectable SiOH densities form when the HF to SDA ratio meets or exceeds a value of 1.5.

Accordingly, this disclosure provides a zeolite composition that is siliceous or comprises a transition metal incorporated into the framework of the zeolite, and comprises a density of silanol groups characterized by infrared spectroscopy as a ratio of the area of O—H vibrations to Si—O—Si overtone vibrations (A_{O—H}/A_{Si—O—Si}), wherein the silanol density (Φ) is about 0.4 or less when the zeolite is siliceous, Φ is about 1 or less when the zeolite comprises titanium (Ti), or Φ is about 2.5 or less when the zeolite comprises niobium (Nb) or tantalum (Ta).

Also, this disclosure provides a zeolite composition comprising a metal or metalloid incorporated into the framework of the zeolite and a density of silanol groups characterized by infrared spectroscopy as a ratio of the area of O—H vibrations to Si—O—Si overtone vibrations (A_{O—H}/A_{Si—O—Si}), wherein the silanol density (Φ) is about 0.4 or less; or the hydrophobic zeolite composition comprising a metal or metalloid that is not Ti, Nb, or Ta, and the silanol density is about 3 or less.

Additionally, this disclosure provides a method for forming a hydrophobic zeolite comprising contacting hydrofluoric acid (HF) and a zeolite synthesis gel comprising a hydroxylated structure directing agent (SDA-OH); wherein the HF and SDA-OH have a molar ratio (moles HF/moles SDA-OH) of greater than about 1, or greater than 0.1 and less than 1.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. a) Hydrothermal synthesis of zeolites in hydroxide media leads to hydrophilic materials with significant densities of silanol groups, while zeolites crystallized in fluoride media contain fewer silanol defects and are hydrophobic in comparison, b) Shows tunable silanol density by varying HF:SDA ratio from 0 to 2 FIG. 2. X-ray diffractograms for a) Si-MFI-F(x), b) Ti-MFI-F(x), c) Nb-MFI-F(x), and Ta-MFI-F(x). Diffractograms are vertically offset for clarity. Graphs show X-ray diffractograms for all M-MFI-F(x) discussed within this study. All diffractograms possess diffraction patterns that are indicative of the MFI framework. In the cases of Ta-MFI-F(l, 1.5), however, there are a large overlapping features around 7.5 and 22.5 degrees, which are indicative of amorphous SiO₂ domains.

FIG. 3. a) X-ray diffractograms for Si-MFI-F(x) and b) diffraction peak centers for (101) and (200) reflections as a function of HF to TPAOH ratio. Diffractograms are vertically offset for clarity. Dashed lines in panel b) represent linear fits. Graphs show that X-ray diffraction peaks for the (101) and (200) reflections within Si-MFI-F(x) increase monotonically with the HF:TPAOH ratio, by a value of 0.2 degrees between Si-MFI-F(0) and Si-MFI-F(1.5). The diffraction peaks that correspond to the (101) and (200) reflections of MFI at ˜8 and ˜9 degrees decrease monotonically as the HF:TPAOH ratio decreases and span a range of 0.2 degrees between HF to TPAOH ratios of 1.5 and zero. The shift in diffraction peak positions to lower angles with an increase in SiOH density suggests that the hydrogen bonding interactions among —OH functions in framework vacancies slightly expand the unit cell of MFI relative to the defect-free structure.

FIG. 4. Scanning electron micrographs of (a) Ti-MFI-F(0) and (b) Ti-MFI-F(1).

FIG. 5. Infrared spectra of Si-, Ti-, Nb-, and Ta-MFI-F(0) at ambient conditions. All spectra are normalized to the framework vibration at ˜1080 cm⁻¹ and are vertically offset for clarity.

FIG. 6. Infrared spectra of Si-, Ti-, Nb-, and Ta-MFI-F(1.5) at ambient conditions. All spectra are normalized to the framework vibration at ˜1080 cm⁻¹ and are vertically offset for clarity.

FIG. 7. Diffuse Reflectance UV-vis Spectra. Tauc plots for a) Ti-MFI-F(x), b) Nb-MFI-F(x), and c) Ta-MFI-F(x). All plots were normalized to the most intense feature around 5.2 eV and are vertically offset for clarity. Graphs show that, with the exception of Ta-MFI-F(1.5), all M-MFI-F(x) contain a single UV-vis absorbance feature around 5.2 eV. The small absorbance feature at 4.2 eV for Ta-MFI-F(1.5) corresponds to a small quantity of bulk Ta₂O₅. The leading edge (4.8-5.0 eV) for each Tauc plot was fit using a line to extrapolate the x intercept, which is equal to the band gap of the material.

FIG. 8. Raman spectra (λₑₓ=532 nm) of a) M-MFI-F(0) and b) M-MFI-F(1.5) materials. All features are normalized to the most intense feature and are vertically offset for clarity. Graphs show Raman spectra of all M-MFI-F(0) and M-MFI-F(1.5) possess vibrational features between 300-500 cm⁻¹ that is characteristic of the MFI framework. Bulk TiO₂, Nb₂O₅, and Ta₂O₅ possess strong scattering features located at 140, 680, and 250 cm⁻¹, respectively. Notably, none of the Raman spectra for Ti-, Nb-, or Ta-bearing MFI materials contain any scattering features that are reminiscent of the corresponding bulk metal oxide domains. Consequently, these data, in conjunction with our ATR-IR measurements (FIG. 5) and DRUV-vis spectra strongly suggest that these materials contain predominantly monomeric metal atoms that are substituted into the framework of MFI.

FIG. 9. Infrared spectra of dehydrated Ti-MFI-F(x) (x=0, 0.33, 0.66, 1, 1.25, 1.5) at 573 K (50 cm⁻³ min⁻¹ He). All spectra are normalized to the v(Si—O—Si) overtone at 1865 cm⁻¹ and are vertically offset for clarity.

FIG. 10. Infrared spectra of dehydrated a) Si-MFI-F(x), b) Nb-MFI-F(x), and Ta-MFI-F(x) at 573 K in flowing He (50 cm³ min⁻¹). All spectra are normalized to the v(Si—O—Si) overtone at 1865 cm⁻¹ and are vertically offset for clarity. Graphs show a series of infrared (IR) spectra of Si, Nb-, and Ta-MFI-F(x) (x=0, 0.33, 1, 1.25, or 1.5) at 573 K to desorb adsorbed volatile compounds. All spectra possess vibrational features at 1990 and 1865 cm⁻¹ that correspond to v(Si—O—Si) overtones from the MFI framework. The broad features between 3300-3750 cm⁻¹ are attributed to v(O—H) of the SiOH within these materials. The sharp feature at 3740 cm⁻¹ corresponds to v(O—H) of isolated SiOH, which do not interact with other SiOH species. The broad bimodal feature with peak centers at 3680 and 3540 cm⁻¹ represents (SiOH)ₓ groups that contain multiple, proximate hydrogen-bonded —OH functions.

FIG. 11. Relative SiOH densities, ϕ_{IR}, as a function of HF:TPAOH molar ratio (i.e., x) for Si-MFI-F(x) (●), Ti-MFI-F(x) (▴), Nb-MFI-F(x) (▪), and Ta-MFI-F(x) (▾). The dashed line represents a concatenated linear on all MFI materials.

FIG. 12. Metal Content within M-MFI-F(x) as a Function of HF to TPAOH Ratio. The Ti, Nb, and Ta metal context within M-MFI-F(x) zeolites decreases linearly with the HF to TPAOH ratio within the synthesis gel, because HF condenses with M(OH)_{z} complexes to form stable M(OH)ₓF_{y} species that are not incorporated into the MFI framework.

FIG. 13. The measured Ti to Si ratio within Ti-MFI-F(1.5) as a function of the Ti-to-Si ratio within the synthesis gel. The right and top axes represent the same data plotted as the measured Ti content within Ti-MFI-F(1.5) and the maximum possible Ti content, based upon the synthesis procedure, respectively. The solid gray line represents parity, while the dashed black line is a least-squares regression of the data with an intercept at the origin.

FIG. 14. ¹⁹F NMR spectra of the supernatant from Ti-MFI-F(1.5) (top) and Si-MFI-F(1.5) (bottom) synthesis. The spectra have been normalized to the most intense feature around 130 ppm and are vertically offset for clarity.

FIG. 15. (a) Raman spectra (λₑₓ=532 nm) of the dried supernatant from Si-MFI-F(1.5) (black) and Ti-MFI-F(1.5) (grey) syntheses, (b) Difference between the Raman spectra of the dried supernatants from Ti-MFI-F(1.5) and the Si-MFI-F(1.5) synthesis. The dashed black line in (b) represents the baseline. Demarked Raman features correspond to vibrations originating from zeolite precursors (▾), tetrapropylammonium cations (▴), and colloidal MFI particles (▪).

FIG. 16. Raman spectra (λₑₓ=532 nm) of the dried supernatant from Si-MFI-F(1.5) (black) and Ti-MFI-F(1.5) (grey) syntheses. Graph shows Raman spectra of the dried supernatant from Ti- and Si-MFI-F(1.5) syntheses with an extended x-axis in comparison to FIG. 15.

FIG. 17. Quantity of H₂O adsorbed as a function of relative H₂O pressures (P/P₀) at 293 K into (a) Si-MFI-F(x) and (b) Ti-MFI-F(x). (c) The quantity of H₂O adsorbed at P/P₀=0.2 for Ti-MFI-F(x) (▴) and Si-MFI-F(x) (▾) plotted against values of ϕ_{IR} (i.e., a measure of SiOH density). Within panels (a) and (b), refer to the color-coded legend for each HF to TPAOH ratio. Adsorption isotherms are not vertically offset.

FIG. 18. H₂O adsorption isotherms (293 K) within a) Nb-MFI-F(x) and b) Ta-MFI-F(x). Adsorption isotherms are not vertically offset. Graphs show H₂O adsorption isotherms for Nb- and Ta-MFI-F(0, 1, 1.5) resembles a type I isotherm. When the ratio of HF:TPAOH is increased from 0 to 1, there is 3-fold decrease in the amount of H₂O adsorbed. Further, the uptake of H₂O within M-MFI-F(0) is nearly 8-times greater than within M-MFI-F(1.5).

FIG. 19. Mean number of water molecules bound to framework heteroatoms (Ti, Nb) in MFI as a function of H₂O vapor pressure at 293 K for Ti-MFI-F(1.25) (Δ), Ti-MFI-F(1.5) (▴), Nb-MFI-F(1) (□), Nb-MFI-F(1.5) (▪), or Ta-MFI-F(1.5) (▾). Values are calculated from the difference between the H₂O uptake on a given material and Si-MFI-F(x), which is then normalized by the number of metal atoms. The saturation vapor pressure of H₂O (Pₛₐₜ) at 293 K is 2.34 kPa.

FIG. 20. N₂ Adsorption Isotherms over Ti-MFI-F(x). Representative N₂ adsorption isotherms (77 K) over Ti-MFI-F(x) samples.

FIG. 21. a) Infrared spectra of dehydrated Ti-MWW-F(x) (x=0, 0.25, 0.3, 0.4, or 0.5) at 573 K (50 cm⁻³ min⁻¹ He). All spectra are normalized to the v(Si—O—Si) overtone at 1865 cm⁻¹ and are vertically offset for clarity, b) Relative SiOH densities, ϕ_{IR}, as a function of HF:TMAdaOH molar ratio (i.e., x) for Ti-MWW-F(x). The dashed line represents a linear fit. TMAdaOH=Trimethyladamantylammonium hydroxide.

FIG. 22. a) Infrared spectra of dehydrated Ti-BEA-F(x) (x=0.5 or 1) at 573 K (50 cm⁻³ min⁻¹ He). All spectra are normalized to the v(Si—O—Si) overtone at 1865 cm⁻¹ and are vertically offset for clarity, b) Relative SiOH densities, ϕ_{IR}, as a function of HF:TEAOH molar ratio (i.e., x) for Ti-BEA-F(x). The dashed line represents a linear fit. TEAOH=Tetraethylammonium hydroxide.

### DETAILED DESCRIPTION

The type and density of structural defects within zeolites and zeotypes affect the stabilities of adsorbed species, which, in turn, impact the performance of these materials as catalysts and adsorbents. Despite the recognized importance of silanol groups (SiOH) on the properties of a zeolite catalyst or adsorbent, the densities of SiOH have not been quantitatively linked to the concentration of hydroxide (OH⁻) and fluoride (F⁻) ions within the synthesis gel. Here, we present a method for the synthesis of siliceous or heteroatom-substituted MFI zeolites (M-MFI; M=Si, Ti, Nb, or Ta) with tunable densities of SiOH, which depend simply on the ratio of hydrofluoric acid (HF) to structure-directing agent (SDA; tetrapropylammonium hydroxide) used within the synthesis gel. The equilibrated ion exchange between OH⁻ and F⁻ ions forms tetrapropylammonium fluoride in situ, which does not lead to the formation of SiOH defects within M-MFI.

Comparisons of infrared spectra from 15 distinct M-MFI materials show that the densities of SiOH groups within M-MFI decrease linearly with the ratio of HF:SDA, independent of the identity of the heteroatom within the framework. Materials synthesized within purely OH⁻ media possess SiOH densities 3- and 100-times greater than analogous materials synthesized with HF:SDA ratios of 1 and 1.5, respectively. The use of HF forms metal-fluoride complexes, detected by Raman spectroscopy, which are not readily incorporated into the zeolite framework during synthesis and leads to a decrease in the efficiency of transition metal incorporation with increasing amounts of HF. The quantity of the heteroatom incorporated into the framework increases linearly with the concentration of metal precursor in the synthesis gel, which provides a method to mitigate the lower yields introduced by the use of HF.

Comparisons between H₂O vapor adsorption isotherms show that M-MFI materials synthesized with an HF:SDA ratio of 1.5 adsorb 4-10-fold less H₂O than M-MFI synthesized with equal amounts of HF and SDA and 100-times less H₂O than M-MFI synthesized in OH⁻ media. Comparisons of water uptake within hydrophobic M-MFI materials show that framework Ti and Nb sites stabilize 5 and 7-8 H₂O molecules, respectively, near saturation vapor pressures. These findings provide a flexible strategy to control the densities of silanol and hydroxyl groups (e.g., Nb—OH) within MFI and will likely extend to the synthesis of other zeolite frameworks.

Additional information and data supporting the invention can be found in the following publication by the inventors: Chem. Mater 2020, 32, 7425-7437 and its Supporting Information, which is incorporated herein by reference in its entity.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the end-points of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture.

An “effective amount” refers to an amount effective to bring about a recited effect, such as an amount necessary to form products in a reaction mixture. Determination of an effective amount is typically within the capacity of persons skilled in the art, especially in light of the detailed disclosure provided herein. The term “effective amount” is intended to include an amount of a compound or reagent described herein, or an amount of a combination of compounds or reagents described herein, e.g., that is effective to form products in a reaction mixture. Thus, an “effective amount” generally means an amount that provides the desired effect.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

This disclosure provides methods of making the compounds and compositions of the invention. The compounds and compositions can be prepared by any of the applicable techniques described herein, optionally in combination with standard techniques of zeolite synthesis. Many techniques of zeolite synthesis are well known in the art. However, many of these techniques are elaborated in Verified Syntheses of Zeolitic Materials, 3^{rd} Revised Ed., International Zeolite Association (Elsevier), S. Mintova and N. Barrier, 2016, ISBN 9780692685396, and Atlas of Zeolite Framework Types, 6^{th} Revised Ed., International Zeolite Association (Elsevier), Ch. Baerlocher, L. B. McCusker, and D. H. Olson, 2007, ISBN 9780444530646. For organic synthesis techniques, see Compendium of Organic Synthetic Methods (John Wiley & Sons, New York), Vol. 1, Ian T. Harrison and Shuyen Harrison, 1971; Vol. 2, Ian T. Harrison and Shuyen Harrison, 1974; Vol. 3, Louis S. Hegedus and Leroy Wade, 1977; Vol. 4, Leroy G. Wade, Jr., 1980; Vol. 5, Leroy G. Wade, Jr., 1984; and Vol. 6; as well as standard organic reference texts such as March's Advanced Organic Chemistry: Reactions, Mechanisms, and Structure, 5th Ed., by M. B. Smith and J. March (John Wiley & Sons, New York, 2001).

The term “halo” or “halide” refers to fluoro, chloro, bromo, or iodo. Similarly, the term “halogen” refers to fluorine, chlorine, bromine, and iodine.

The term “alkyl” refers to a branched or unbranched hydrocarbon having, for example, from 1-20 carbon atoms, and often 1-12, 1-10, 1-8, 1-6, or 1-4 carbon atoms; or for example, a range between 1-20 carbon atoms, such as 2-6, 3-6, 2-8, or 3-8 carbon atoms. As used herein, the term “alkyl” also encompasses a “cycloalkyl”, defined below. Examples include, but are not limited to, methyl, ethyl, 1-propyl, 2-propyl (iso-propyl), 1-butyl, 2-methyl-1-propyl (isobutyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like.

The term “cycloalkyl” refers to cyclic alkyl groups of, for example, from 3 to 10 carbon atoms having a single cyclic ring or multiple condensed rings. Cycloalkyl groups include, by way of example, single ring structures such as cyclopropyl, cyclobutyl, cyclopentyl, cyclooctyl, and the like, or multiple ring structures such as adamantyl, and the like.

As used herein, the term “substituted” or “substituent” is intended to indicate that one or more (for example, in various embodiments, 1-10; in other embodiments, 1-6; in some embodiments 1, 2, 3, 4, or 5; in certain embodiments, 1, 2, or 3; and in other embodiments, 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound.

### Embodiments of the Technology

This disclosure provides a hydrophobic zeolite composition that is siliceous or comprises a metal incorporated into the framework of the zeolite and comprises a density of silanol groups characterized by as the ratio of O—H moieties to Si—O—Si moieties (O—H/Si—O—Si). In various embodiments, the silanol density (Φ_{IR} or Φ) is about 0.4 or less when the zeolite is siliceous, Φ is about 1 or less when the zeolite comprises titanium (Ti), or Φ is about 2.5 or less when the zeolite comprises niobium (Nb) or tantalum (Ta).

Phi (Φ) is equal to the area of the infrared peak corresponding to O—H moieties (3200-3800 cm⁻¹) to that for Si—O—Si moieties (selected from peaks between 1600-2000 cm⁻¹) dependent upon zeolite framework (see equation 1).

In various embodiments, the ratio is characterized spectroscopically. In various embodiments, the ratio is characterized by infrared spectroscopy.

In various embodiments, the metal is a transition metal or metalloid. In various embodiments, the transition metal comprises Ti, Nb, or Ta. In various embodiments, the framework type of the zeolite is Socony Mobil-5 (MFI), CHA, Beta (BEA), MWW, or CIT-5. In various embodiments, the zeolite is siliceous and the silanol density is about 0.01 to about 0.3. In various embodiments, the zeolite comprises Ti, Nb, or Ta and the silanol density is about 0.01 to about 0.5. In various embodiments, the zeolite comprises Ti, Nb, or Ta and the silanol density is about 0.01 to about 0.4. In various embodiments, the metal or metalloid is Ti, Nb, Ta, Al, B, Ga, Ge, Hf, Sn, Zr, or a combination thereof.

In various embodiments, the siliceous zeolite or the zeolite comprising a metal or metalloid incorporated into the framework has a silanol density (Φ_{IR}) of about 0.001 to about 0.01, about 0.02, about 0.03, about 0.04, about 0.05, about 0.06, about 0.07, about 0.08, about 0.09, about 0.1, about 0.15, about 0.2, about 0.25, about 0.3, about 0.35, about 0.4, about 0.45, about 0.5, about 0.55, about 0.6, about 0.65, about 0.7, about 0.75, about 0.8, about 0.85, about 0.9, about 0.95, about 1.0, about 1.1, about 1.2, about 1.25, about 1.3, about 1.4, about 1.5, about 1.6, about 1.7, about 1.8, about 1.9, about 2.0, about 2.2, about 2.4, about 2.6, about 2.8, about 3.0, about 3.5, about 4.0, about 0.005 to about 0.3, about 0.01 to about 1.0, or 0 to 5. In various embodiments, the zeolite has no measurable or detectable silanol (SiOH) defects, or no measurable or detectable SiOH contributing to H₂O adsorption, for example, as determined by infrared spectroscopy.

Also, this disclosure provides a zeolite composition comprising a metal or metalloid incorporated into the framework of the zeolite and a density of silanol groups characterized by infrared spectroscopy as the ratio of O—H moieties to Si—O—Si moieties (O—H/Si—O—Si), wherein the silanol density (Φ) is about 0.4 or less. In other embodiments, the hydrophobic zeolite composition comprising a metal or metalloid that is not Ti, Nb, or Ta, and the silanol density is about 3 or less. In various embodiments the zeolite is hydrophobic and/or has an MFI framework type.

In various embodiments, the zeolite comprises Al, B, Ga, Ge, Hf, Sn, or Zr and the silanol density is about is about 3 or less. In various embodiments, the zeolite comprises Al, B, Ga, Ge, Hf, Sn, or Zr and the silanol density is about 0.01 to about 0.5.

Additionally, this disclosure provides a method for forming a hydrophobic zeolite comprising: contacting hydrofluoric acid (HF) and a zeolite synthesis gel comprising a hydroxylated structure directing agent (SDA-OH); wherein the HF and SDA-OH have a molar ratio (moles HF/moles SDA-OH) of greater than about 1, or greater than 0.1 and less than 1.

In various embodiments, the molar ratio is 0.001 to about 0.01, about 0.02, about 0.03, about 0.04, about 0.05, about 0.06, about 0.07, about 0.08, about 0.09, about 0.1, about 0.15, about 0.2, about 0.25, about 0.3, about 0.35, about 0.4, about 0.45, about 0.5, about 0.55, about 0.6, about 0.65, about 0.7, about 0.75, about 0.8, about 0.85, about 0.9, about 0.95, about 1.0, about 1.1, about 1.2, about 1.25, about 1.3, about 1.4, about 1.5, about 1.6, about 1.7, about 1.8, about 1.9, about 2.0, about 2.2, about 2.4, about 2.6, about 2.8, about 3.0, about 3.5, about 4.0, about 0.005 to about 0.3, about 0.01 to about 1.0, or 0 to 5.

In various embodiments, the molar ratio is about 1.1 to about 2.0, the molar ratio is about 1.25 to about 1.5, about 1.05 to 1.9, about 1.2 to about 1.8.

In various embodiments, the formed hydrophobic zeolite comprises a density of silanol groups characterized as the ratio of O—H moieties to Si—O—Si moieties (O—H/Si—O—Si), wherein the silanol density (Φ) is about 3 or less. In various embodiments, the ratio is characterized spectroscopically, or by infrared spectroscopy.

In various embodiments, the SDA-OH is an alkali hydroxide, quaternary ammonium hydroxide, quaternary imidazolium hydroxide, diquaternary ammonium hydroxide, quaternary phosphonium hydroxide, diquaternary phosphonium hydroxide, or combination thereof. In some embodiments, the SDA-OH is tetrapropylammonium hydroxide.

In various embodiments, the zeolite synthesis gel comprises a hydrolyzed tetraalkylorthosilicate. In various embodiments, the zeolite synthesis gel comprises a hydrolyzed metal alkoxide or hydrolyzed metal halide. In various embodiments, the halide moiety of the metal halide is fluorine, chlorine, bromine, or iodine. In various embodiments, the zeolite synthesis gel comprises the zeolite synthesis gel comprises a hydrolyzed tetraalkylorthosilicate and a hydrolyzed metal alkoxide. In various embodiments, the zeolite synthesis gel comprises the metal of the hydrolyzed metal alkoxide is titanium, niobium, tantalum, aluminum, boron, gallium, germanium, hafnium, tine, or zirconium.

In various other embodiments, the method includes forming the zeolite synthesis gel comprising contacting SDA-OH and a composition comprising a tetraalkylorthosilicate or fumed silica and optionally a transition metal alkoxide or metal halide; wherein SDA-OH is a quaternary tetraalkylammonium hydroxide.

In various other embodiments, the hydrophobic zeolite is formed under suitable hydrothermal synthesis conditions. In various other embodiments, the suitable hydrothermal synthesis conditions comprises seeding with a suitable zeolite. In various other embodiments, the formed hydrophobic zeolite has a Socony Mobil-5 (MFI), Beta (BEA), or MWW framework type.

### Other Aspects of the Technology

This disclosure provides a method of synthesizing a zeolite or zeotype comprising providing a synthesis gel for synthesizing the zeolite or zeotype, the synthesis gel comprising an F⁻ source and a structure directing agent (SDA), wherein a ratio of the F⁻ source to the SDA (F⁻ source:SDA) is in a range of 0 to 2; and synthesizing the zeolite or zeotype using the synthesis gel.

In various embodiments, the F⁻ source is HF or NH₄F. In various embodiments, the synthesis gel further comprises a heteroatom precurser. In various embodiments, the synthesis gel further comprises a metal precurser. In various embodiments, the metal precursor is a heteroatom alkoxide. In various embodiments, the metal precursor is one of TiBO, NbEO, and TaEO. In various embodiments, the synthesizing the zeolite or zeotype is a hydrothermal synthesis. In various embodiments, the zeolite or zeotype is a siliceous or heteroatom-incorporated MFI zeolite (M-MFI). In various embodiments, M is one of Si, Ti, Nb, and Ta. In various embodiments, the zeolite or zeotype is a hydrophobic zeolite or zeotype.

In various embodiments, the SDA is one of an alkali metal, tetraalkylammonium, imidazolium, diquaternaryammonium, phosphonium, and diquarternaryphosponium cations. In various embodiments, the SDA is TPAOH. In various embodiments, varying amounts of HF are added to the synthesis gel to control the density of polar SiOH functions.

In various embodiments, the method further comprises tuning an SiOH density of the zeolite or zeotype by adjusting the ratio of F⁻ source:SDA. In various embodiments, the ratio of F⁻ source:SDA is between 0 and 1.5. In various embodiments, the ratio of F⁻ source:SDA is greater than 1. In various embodiments, the ratio of F⁻ source:SDA is greater than 1.25. In various embodiments, the ratio of F⁻ source:SDA is about 1.25, 1.25, about 1.5, or 1.5.

In various embodiments, providing the synthesis gel comprises: providing a first homogenous solution comprising a metal precursor; providing a mixture comprising a structure directing agent (SDA); adding the mixture comprising the SDA to the homogenous solution, whereby hydrolysis occurs, to produce a second homogenous solution; evaporating alcohol in the second homogenous solution formed through the hydrolysis to form the synthesis gel; adding the F— source to the synthesis gel to form the zeolite or zeotype. In various embodiments, the method further comprises adding Ti- or Si-MFI seeds to the synthesis gel to promote crystallization.

In various embodiments, providing the first homogenous solution comprises: dissolving a metal precursor in tetraethylorthosilicate (TEOS) to form the first homogenous solution. In various embodiments, providing the mixture comprises: providing a mixture of TPAOH and H₂O. In various embodiments, adding the mixture comprising the SDA to the homogenous solution comprises adding a mixture of TPAOH and H₂O to a TEOS solution to produce a homogeneous solution. In various embodiments, adding the F— source to the synthesis gel to form the zeolite or zeotype further comprises heating the synthesis gel in which the F⁻ source is added to form the zeolite or zeotype.

In various embodiments, providing the synthesis gel comprises: dissolving a metal precursor in tetraethylorthosilicate (TEOS) to form a homogenous TEOS solution; cooling the TEOS solution; providing a mixture of TPAOH and H₂O; cooling the mixture of TPAOH and H₂O; adding the mixture of TPAOH and H₂O to the TEOS solution, whereby hydrolysis occurs, to produce a homogeneous solution; evaporating alcohol formed through the hydrolysis to form a synthesis gel; adding the F⁻ source to the synthesis gel; heating the synthesis gel to form the zeolite or zeotype.

In various embodiments, the method further comprises adding Ti- or Si-MFI seeds to the synthesis gel to promote crystallization. In various embodiments, adding the mixture of TPAOH and H₂O to the TEOS solution to produce a homogenous solution comprises warming the solution and stirring to produce the homogenous solution.

In various embodiments, the solution is warmed to a temperature in the range of 310 K to 280K or is warmed to a temperature of 298 K, and stirring is conducted for 10 to 14 hr or is conducted for 12 hr. In various embodiments, the homogenous solution is a homogenous clear solution indicating successful hydrolysis of the metal precursor and TEOS. In various embodiments, cooling the TEOS solution comprises cooling the homogenous solution to a temperature in the range of 260-290 K, or cooling the homogenous solution to 273 K. In various embodiments, cooling the mixture of TPAOH and H₂O comprises cooling the mixture of TPAOH and H₂O to a temperature in the range of 260 to 290 K, or cooling the homogenous solution to 273 K.

In various embodiments, heating the synthesis gel comprises heating the synthesis gel to a temperature in the range of 430 K to 460K or to a temperature of 43K for a period of time in the range of 72-504 h. In various embodiments, heating the synthesis gel to form the zeolite or zeotype further comprises, after heating the synthesis gel, recovering solids through centrifugation, washing and drying the recovered solids, and heating the dried solids to produce the zeolite or zeotype. In various embodiments, heating the dried solids comprises heating the dried solids in flowing air to a temperature in the range of 810 to 830 K at 1 K min⁻¹ and held for 10 h to produce the zeolite or zeotype.

In various embodiments, the synthesis gel in which the F⁻ source is added comprises an approximate composition of 1 Si:a M:0.43 TPAOH:b HF:28.3 H₂O or a composition of 1 Si:a M:0.43 TPAOH:b HF:28.3 H₂O, where a and b depends on the amount of metal precursor and HF used, respectively. In various embodiments, a density of SiOH groups within the zeolite or zeotype decreases linearly with the ratio of F⁻ source:SDA.

Furthermore, this disclosure provides a material comprising a siliceous or heteroatom-substituted MFI zeolite M-MFI-F(x) formed by hydrothermal synthesis of transition metal-substituted MFI (M-MFI) in hydroxide (OH⁻), fluoride (F⁻) media, or mixtures thereof, where x is the ratio of HF to a structure directing agent (HF:SDA) in a synthesis gel used in the synthesis.

In various embodiments, x is in the range of 0-2, or x is in the range of 0-1.5, or x is greater than or equal to 1.25, or x is greater than 0, or x is less than 2, or x is greater than 0 and less than 2. In various embodiments, M is any one of Si, Ti, Nb, or Ta. In various embodiments, the SDA is TPAOH.

### Effects of Hydrofluoric Acid Concentration on the Density of Silanol Groups and Water Adsorption in Hydrothermally Synthesized Transition Metal Substituted Silicalite-1

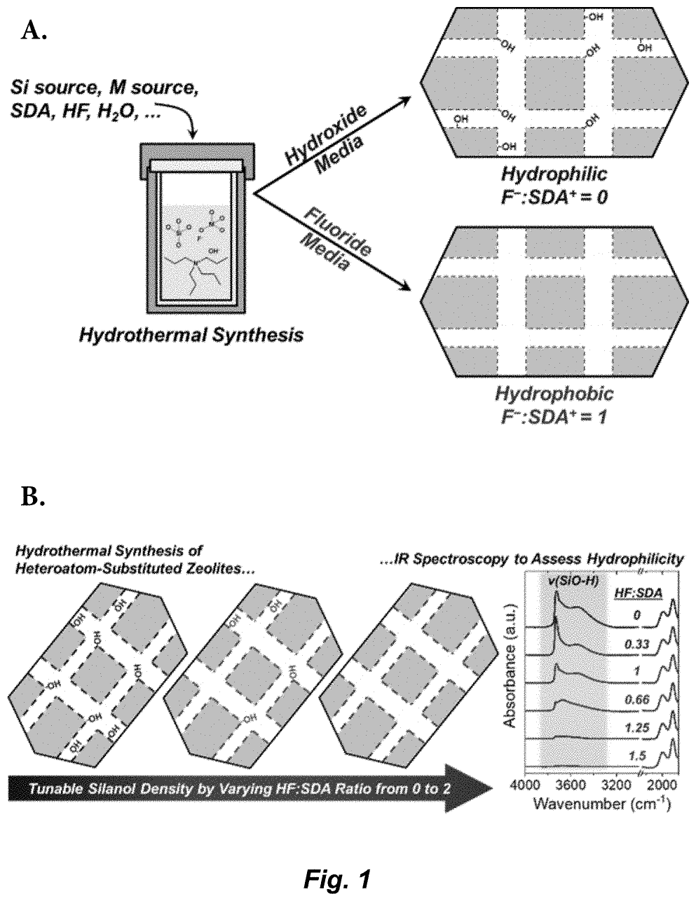

The silanol density of a given zeotype has traditionally been controlled through hydrothermal synthesis in either a hydroxide (OH⁻) or a fluoride (F⁻) media (FIG. 1). Hydrothermal synthesis involves the crystallization of a zeolite from a synthesis gel that contains a silicon source and a structure-directing agent (SDA; e.g., alkali, tetraalkylammonium, imidazolium, diquaternaryammonium, phosphonium, or diquartemaryphosponium cations). The presence of OH⁻ anions leads to the formation of anionic framework vacancy defects, because solvated OH⁻ requires that zeolite precursor units self-assemble around these ions. In contrast, F⁻ ions form a tighter ion pair with the cationic SDA and yield materials with lower densities of internal silanol defects.

The majority of studies on hydrophilic and hydrophobic zeolites compare materials synthesized with SDAs that are predominantly in OH⁻ form or which are combined with an equimolar amount of a F⁻ source (e.g., HF or NH₄F). The functional dependence of the final SiOH density on the concentration of F⁻ ions within the synthesis gel has, however, not been determined. The functional dependence of the final SiOH density on the concentration of F⁻ ions within the synthesis gel has, however, not been determined. Moreover, the presence of F⁻ generally decreases the efficiency of heteroatom incorporation into synthesized materials, which affects the density of active sites within the final zeolite. Consequently, the community would greatly benefit from synthetic methods and characterization data that demonstrate how the concentration of F⁻ ions affects the incorporation of heteroatoms and can be used to control SiOH density within a given zeolite.

Here, we report the hydrothermal synthesis of siliceous and heteroatom-incorporated MFI zeolites (M-MFI; where M represents Si, Ti, Nb, and Ta) with control over the density of SiOH functions. MFI materials are synthesized using tetrapropylammonium hydroxide (TPAOH) and varying amounts of HF (HF:TPAOH ratios from 0-2) to control the density of SiOH groups. Transmission infrared spectra of dehydrated materials show that the relative density of SiOH functions decreases by ˜66% when the HF:SDA ratio increases from 0 to 1. M-MFI with nearly undetectable SiOH densities form when the HF to SDA ratio meets or exceeds a value of 1.5. Ion exchange between HF and TPAOH forms TPAF in situ by a reversible reaction presumably near equilibrium. Therefore, near-complete ion exchange requires a stoichiometric excess of HF. F⁻ ions, however, ligand exchange with transition metal complexes to form M(OH)ₓF_{y} species that are detected by Raman spectroscopy. These metal fluoride complexes do not incorporate effectively into the MFI framework. Consequently, the use of excess HF produces materials with significantly fewer SiOH functions but also decreases the efficiency with which the heteroatoms incorporate into the framework.

Vapor-phase H₂O adsorption isotherms show functional differences in M-MFI materials that arise from differences in the density of SiOH. H₂O adsorption resembles a type I isotherm for all materials; yet, the amount of H₂O adsorbed increases monotonically with the density of SiOH groups. Hydrophobic M-MFI synthesized using HF to SDA ratios equal to 1.5 adsorb ˜10 and ˜100-fold less H₂O than M-MFI synthesized with HF to SDA ratios of 1 and 0, respectively. M-MFI synthesized using HF to SDA ratios less than unity adsorb indistinguishable amounts of H₂O, because SiOH groups spontaneously nucleate H₂O clusters in these materials. Comparisons among hydrophobic M-MFI materials reveal that H₂O clusters preferentially adsorb to Lewis and Brønsted acid sites associated with the framework heteroatoms. Thermodynamic analysis of H₂O adsorption isotherms shows that Lewis acidic Ti atoms stabilize ˜5 H₂O while Brønsted acidic Nb adsorption sites form structures consisting of 7-8 H₂O molecules within aqueous media, which may have implications for catalysis or separations. Collectively, the synthesis procedure presented here provides a simple and robust method that extends to the synthesis of other frameworks, which enables precise control over the density of SiOH groups within a zeolite material.

### Results and Discussion

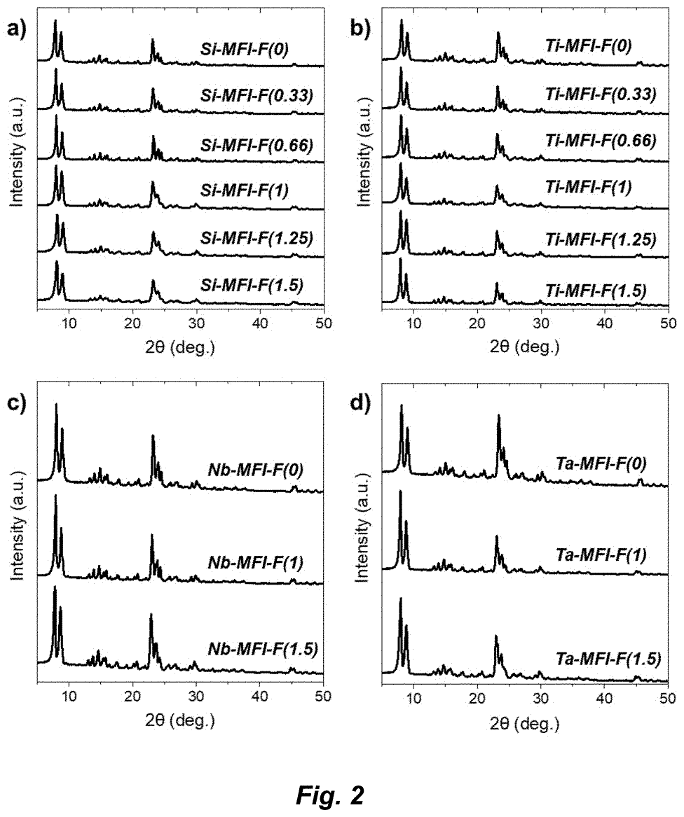

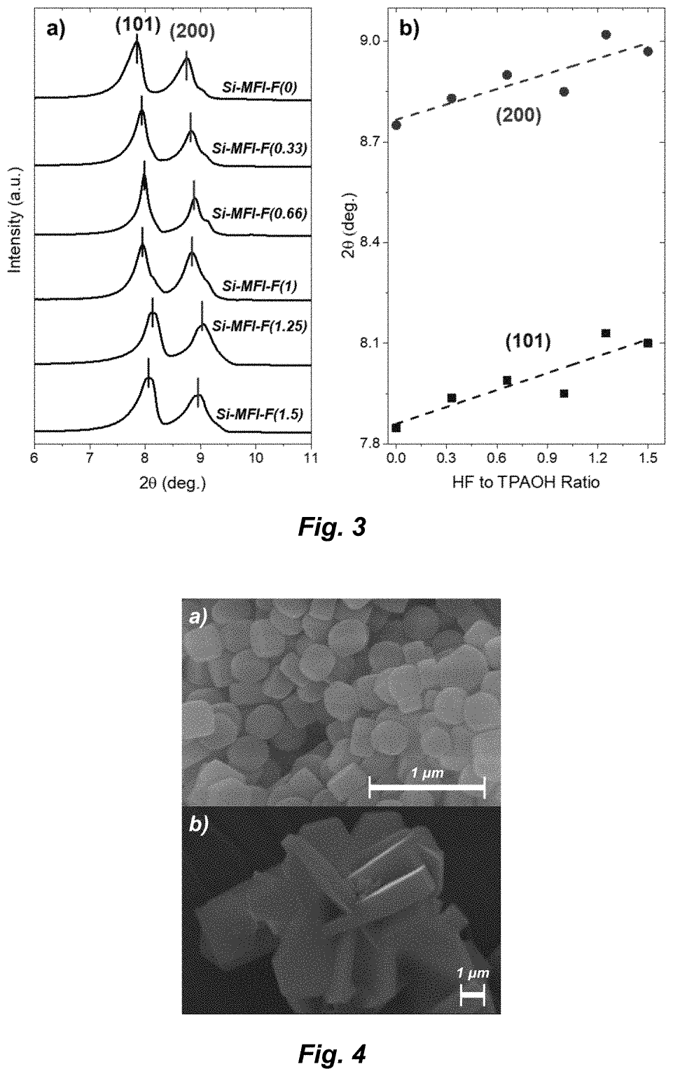

Tuning Silanol Density by Controlling the HF to SDA Ratio in the Synthesis Gel. Hydrothermal synthesis of transition metal-substituted MFI (M-MFI; Si, Ti, Nb, or Ta) in hydroxide (OH⁻) media, fluoride (F⁻) media, or mixtures thereof, produce materials with varying silanol (SiOH) densities. Each M-MFI sample is denoted as M-MFI-F(x), where x is the ratio of HF to TPAOH in the synthesis gel. All M-MFI-F(x) show X-ray diffraction patterns that are consistent with phase-pure MFI (FIG. 2). The diffraction peaks that correspond to the (101) and (200) reflections of Si-MFI at ˜8 and ˜9 degrees decrease monotonically as the HF:TPAOH ratio decreases and span a range of 0.2 degrees between HF to TPAOH ratios of 1.5 and zero (FIG. 3), suggests there is an expansion of the MFI framework. This is notably different than the contraction of the BEA framework due to the presence of (SiOH)ₓ defects. Interestingly, within Ti-, Nb-, and Ta-MFI samples, there does not appear to be a systematic change in the position of the (101) or (200) reflections. In all cases, M-MFI-F(x) possess the high BET surface areas and micropore volumes (0.12-0.15 cm³ g⁻¹) characteristic of the MFI framework. External surface areas (Table 1) increase with the HF:TPAOH ratio, which correlates with the concomitant increase in the average crystal size of the M-MFI materials.

TABLE 1
Molar ratios of HF to TPAOH, synthesis times, metal loadings,^{a} BET surface areas,^{b}
micropore volumes,^{c} external surface areas,^{c} band edge energies,^{d} and
relative density of SiOH (ϕ_{IR})^{e} within M-MFI-F(x).^{f}

| | | Synthesis | Metal | BET | Micropore | External | Band edge | |
|---|---|---|---|---|---|---|---|---|
| | HF:TPAO | time | loading | Surface area | Volume | Surface Area | energy | |
| SampleName | H Ratio | (days) | (wt. %)^{a} | (m² g⁻¹)^{b} | (cm³ g⁻¹)^{c} | (m² g⁻¹)^{c} | (eV)^{d} | ϕ_{IR}^{e} |
| Si-MFI-F(0) | 0 | 3 | — | 631 | 0.14 | 128 | — | 3.87 |
| Si-MFI-F(0.33) | 0.33 | 7 | — | 402 | 0.14 | 110 | — | 2.70 |
| Si-MFI-F(0.66) | 0.66 | 7 | — | 455 | 0.13 | 174 | — | 1.17 |
| Si-MFI-F(1) | 1 | 7 | — | 551 | 0.15 | 330 | — | 0.41 |
| Si-MFI-F(1.25) | 1.25 | 7 | — | 546 | 0.14 | 338 | — | 0.21 |
| Si-MFI-F(1.5) | 1.5 | 7 | — | 552 | 0.13 | 402 | — | 0.08 |
| Ti-MFI-F(0) | 0 | 3 | 0.27 | 399 | 0.15 | 126 | 4.8 | 3.31 |
| Ti-MFI-F(0.33) | 0.33 | 7 | 0.23 | 361 | 0.14 | 108 | 5.0 | 2.11 |
| Ti-MFI-F(0.66) | 0.66 | 7 | 0.22 | 364 | 0.14 | 304 | 5.0 | 2.05 |
| Ti-MFI-F(1) | 1 | 7 | 0.10 | 367 | 0.13 | 342 | 4.8 | 1.26 |
| Ti-MFI-F(1.25) | 1.25 | 7 | 0.06 | 443 | 0.14 | 398 | 4.8 | 0.25 |
| Ti-MFI-F(1.5) | 1.5 | 7 | 0.04 | 406 | 0.13 | 376 | 4.8 | 0.03 |
| Nb-MFI-F(0) | 0 | 5 | 0.57 | 444 | 0.15 | 122 | 4.8 | 3.04 |
| Nb-MFI-F(1) | 1 | 14 | 0.44 | 333 | 0.14 | 200 | 4.5 | 0.40 |
| Nb-MFI-F(1.5) | 1.5 | 14 | 0.31 | 368 | 0.14 | 320 | 4.6 | 0.10 |
| Ta-MFI-F(0) | 0 | 7 | 1.08 | 518 | 0.15 | 113 | 4.8 | 2.90 |
| Ta-MFI-F(1)^{e} | 1 | 33 | 0.56 | 447 | 0.12 | 189 | 4.9 | 0.40 |
| Ta-MFI-F(1.5)^{e} | 1.5 | 33 | 0.51 | 404 | 0.13 | 289 | 5.0 | 0.13 |

^{a}Measured using EDXRF.
^{b}Determined from physisorption.
^{c}Calculated using the t-plot from N₂ physisorption.
^{d}Measured using DRUV-vis.
^{e}Quantified by infrared spectroscopy of dehydrated M-MFI-F(x).
^{f}The intended weight loadings of all Ti—, Nb—, and Ta-MFI-F(x) within Table 1 were 0.3, 0.6, and 1.2 wt. %, respectively.

The time required to crystallize M-MFI-F(x) samples varies from 3 to more than 33 days and depends on the concentration of F⁻ ions and the identity of the heteroatom. The addition of HF into the synthesis gel increases the crystallization time considerably (Table 1; e.g., 3 to 7 days for Ti- and Si-MFI-F(0) versus M-MFI-F(1)). Zeolite precursors form from the condensation of anionic silyloxy species (e.g., [SiO₂(OH)₂]²⁻, [SiO(OH)₃]⁻) present in an acid-base equilibrium with Si(OH)₄ species. The addition of HF lowers the pH of the synthesis gel, which consequently lowers the concentration of these anionic silyloxy species and slows formation rates of the silicalite-1 precursors.

The identity of the heteroatom incorporated into M-MFI-F(x) also affects rates of crystallization. For example, Si-, Ti-, Nb-, and Ta-MFI-F(0) require up to 3, 3, 5, or 7 days, respectively, under dynamic conditions to fully crystallize. These results agree with prior reports on how the time required to crystallize framework substituted BEA changes depending on the identity of the heteroatom (e.g., Ti, Nb, Ta, Sn). The differences in crystallization rates are exacerbated by the presence of F⁻ ions: Ta-MFI-F(x) requires up to 33 days to yield crystalline materials, while Si- and Ti-MFI-F(x) require only 7 days. It should be noted that the times reported for crystallization are not necessarily optimized. In our hands, Ta-MFI-F(l, 1.5) crystallized for 21 days contain large amorphous domains, detected by XRD; yet, are phase-pure after 33 days under hydrothermal conditions (FIG. 2).

FIG. 4 shows representative scanning electron micrographs of Ti-MFI-F(0) and Ti-MFI-F(1). Ti-MFI synthesized in OH⁻ media consist of ˜300 nm wide cuboids. The addition of F⁻ ions significantly increases the characteristic length of the MFI crystallites and forms plate-like structures that are 300-800 nm thick and 3-5 μm in length.

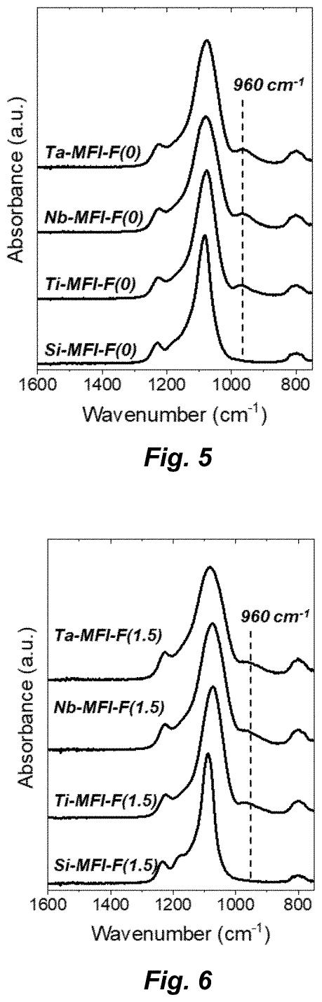

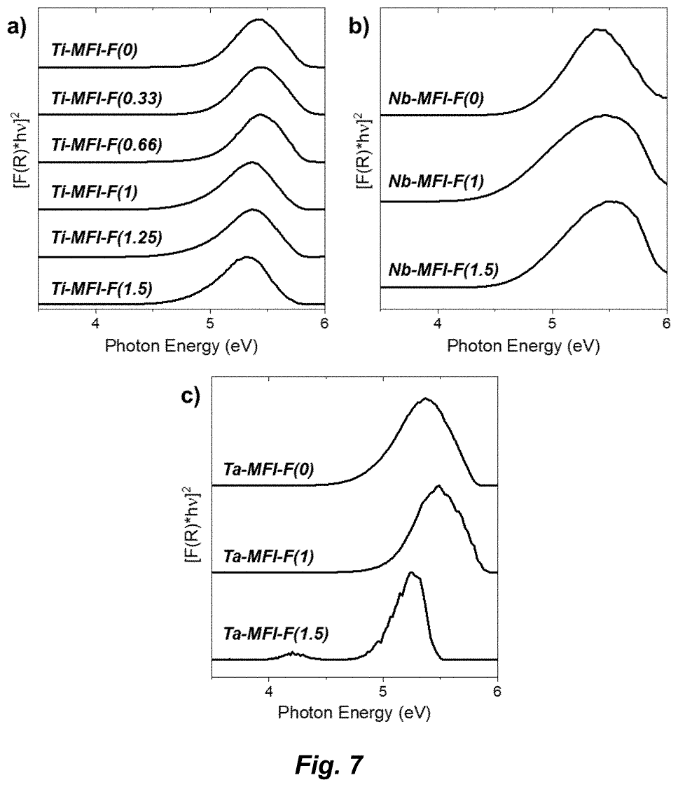

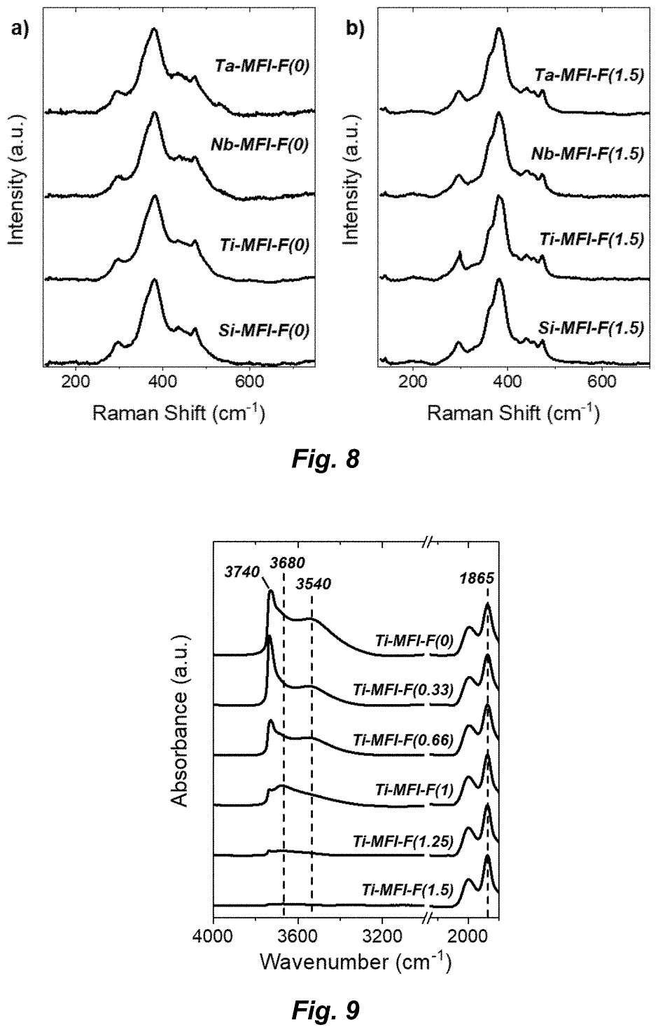

The incorporation of metal atoms into the MFI framework can be confirmed through a combination of infrared (IR), Raman, and UV-vis spectroscopies. FIG. 5 shows attenuate total reflectance-infrared spectra of M-MFI-F(0) samples contain several vibrational features between 800-1300 cm⁻¹. IR spectra of the analogous M-MFI-F(1.5) materials are shown in FIG. 6. The strong features at 800, 1080, and 1230 cm⁻¹ correspond to vibrational modes that are characteristic of zeolite frameworks. The additional feature at 960 cm⁻¹ within Ti-, Nb-, and Ta-MFI-F(0) and Ti-MFI-F(1.5) materials (FIG. 5 and FIG. 6) correspond to v(Si—O-M) of framework-substituted heteroatoms. All M-MFI-F(x) possess a single prominent UV-vis absorbance feature around 5.2-5.5 eV (FIG. 7) that corresponds to the charge transfer from the 2p orbitals of oxygen to the 3d, 4d, or 5d orbitals of Ti⁴⁺, Nb⁵⁺, or Ta⁵⁺, respectively. The band gap for these electronic transitions within M-MFI-F(x) materials are between 4.5-5.0 eV in all cases (Table 1) and are significantly greater than the band gaps reported for the analogous bulk metal oxides (i.e., 3.2 eV for TiO₂, 3.4 eV for Nb₂O₅, 3.9 eV for Ta₂O₅). Finally, FIG. 8 shows Raman spectra of all M-MFI-F(0) and M-MFI-F(1.5) contain only scattering features that are attributed to the MFI framework and do not possess any vibrational features that resemble bulk metal oxide domains. Consequently, this combination of IR, UV-vis, and Raman spectroscopic evidence strongly suggests that the M atoms within each of these materials are highly disperse, incorporated into the MFI framework, and that M-MFI-F(x) samples possess few, if any, MOₓ oligomers or larger agglomerates.

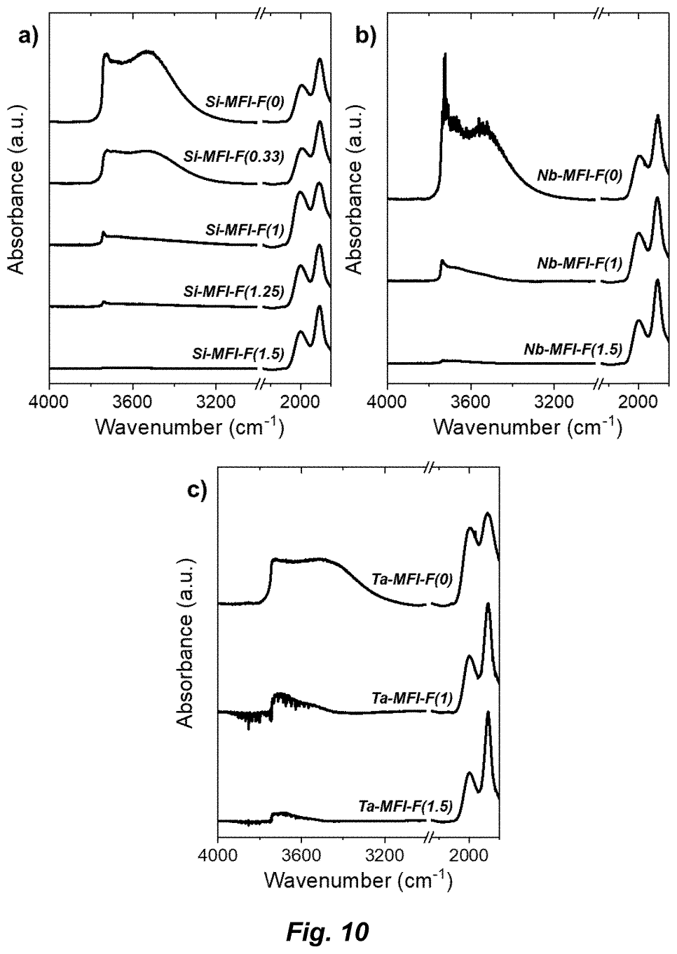

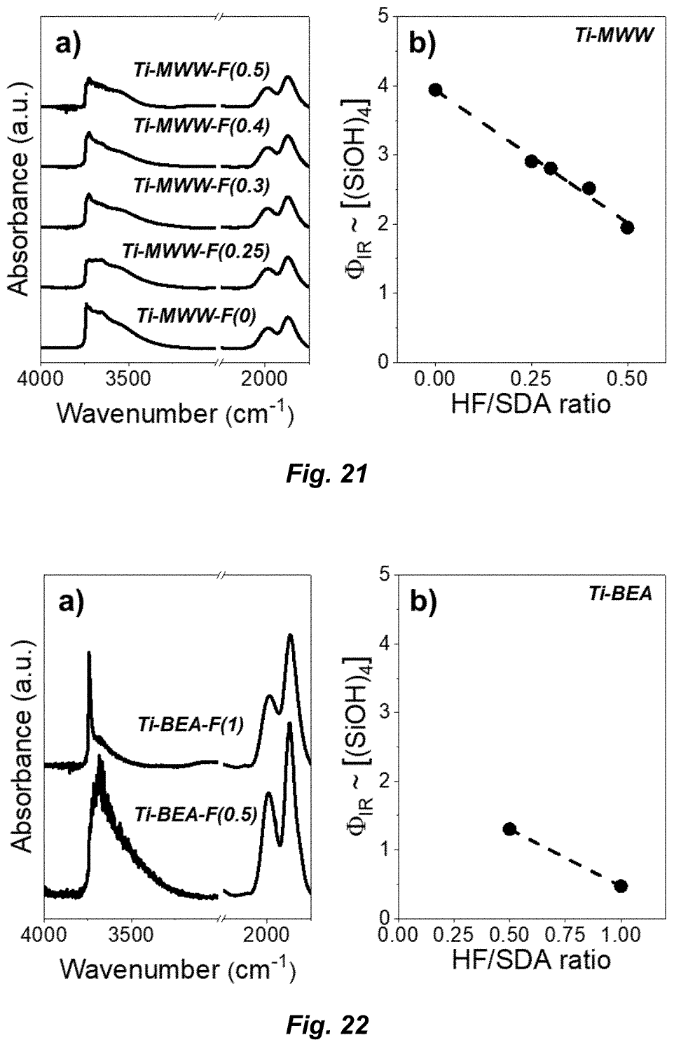

Infrared spectra of M-MFI-F(x) contain vibrational features that can be used as a quantitative estimate for the density of SiOH within a given material. FIG. 9 shows a series of infrared (IR) spectra of Ti-MFI-F(x) (x=0, 0.33, 0.66, 1, 1.25, and 1.5) at 573 K to desorb volatile compounds. IR spectra of the other M-MFI-F(x) materials are available in FIG. 10. These spectra possess vibrational features at 1990 and 1865 cm⁻¹ that correspond to v(Si—O—Si) overtones from the MFI framework, while the broad features between 3300-3750 cm⁻¹ are attributed to v(O—H) of the SiOH within these materials. The sharp feature at 3740 cm⁻¹ corresponds to v(O—H) of isolated SiOH, which do not interact with other SiOH species. The broad bimodal feature with peak centers at 3680 and 3540 cm⁻¹ represents (SiOH)ₓ groups that contain multiple, proximate hydrogen-bonded —OH functions. M-MFI synthesized with HF:TPAOH ratios less than unity possess a broad vibrational feature around 3540 cm⁻¹, which likely corresponds to multiple (SiOH)ₓ defects that interact through hydrogen-bonding interactions. When the HF:TPAOH ratios within the synthesis gel are greater than one, the broad feature at 3540 cm⁻¹ is greatly attenuated, which suggests that the v(O—H) feature located at 3680 cm⁻¹ reflects singular, non-interacting (SiOH)ₓ defects. FIGS. 21a and 22a show infrared spectra of Ti-MWW and Ti-BEA zeolite synthesized using a similar methodology (i.e., by varying the ratio of HF to hydroxide-form SDA (SDA-OH)) also possess attenuated v(O—H) bands with increasing HF:SDA ratios. Unfortunately, the quantification of these densities (in units of (mol SiOH)(g⁻¹)) requires spectral deconvolution of the broad v(O—H) modes and extinction coefficients for each type of SiOH, which are not available.

Zeolites are crystalline forms of SiO₂ that contain predominantly Si—O—Si linkages. As such, v(Si—O—Si) overtone stretches provide a convenient point of normalization for each IR spectra to avoid experimental artifacts when comparison spectra that may arise from irregularities in the pellets and circumvent the absence of extinction molar extinction coefficients for SiOH functions. A quantitative measure for the density of SiOH in M-MFI-F(x), defined as ϕ_{IR}, is thus determined by normalizing the area of v(O—H) (A_{v(O—H)}) relative to that of the v(Si—O—Si) overtone stretch at 1865 cm⁻¹ (A_{v(Si—O—Si)}).

$${ϕ}_{IR} = \frac{{A}_{v ( O - H )}}{{A}_{v ( Si - O - Si )}} \qquad ( 1 )$$

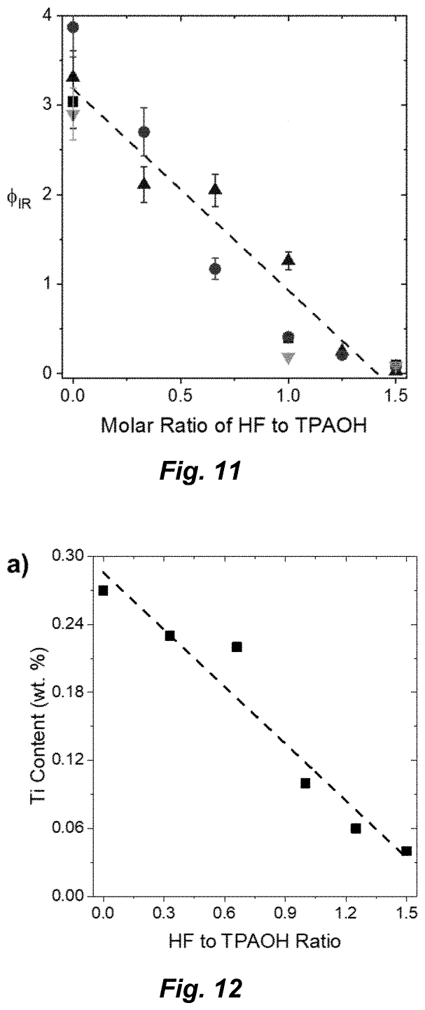

Here, values of ((UR represent the relative density of (SiOH)ₓ among the M-MFI samples and do not correspond to the fraction of Si atoms that exist as SiOH. FIG. 11 shows that values of ϕ_{IR} decrease linearly with the ratio of HF to TPAOH in the synthesis gel for Si-, Ti-, and Nb-MFI-F(x). When the molar ratio of HF to TPAOH in the synthesis gel increases from 0 to 1, the density of SiOH groups decreases by a factor of 4-8. An HF to TPAOH ratio of 1.5 leads to a 30-100-fold decrease in ϕ_{IR} in comparison to M-MFI-F(0). Further increases in the HF:TPAOH ratio, however, do not lead to additional changes in ϕ_{IR}. For example, Ti-MFI-F(2) (i.e., synthesized with a HF to TPAOH ratio of 2) possesses a ϕ_{IR} value of 0.03, which is indistinguishable from Ti-MFI-F(1.5). The role of F⁻ ions reflects a complex network of chemical equilibria that depend on the concentration and identity of the ionic species. FIGS. 21b and 22b show also that values of ϕ_{IR} decrease linearly with the HF:SDA-OH ratio for both Ti-MWW and Ti-BEA synthesis, which strongly suggests that these methods can be extended to the synthesis of other zeolitic frameworks. Collectively, these findings show that the density of SiOH functions within M-MFI zeolites can be systematically varied by changing the HF to TPAOH ratio within the synthesis gel.

Ion Exchange Reactions with Fluoride Anions that Affect Silanol Density and Metal Incorporation. Hydroxide anions lead to the formation of (SiOH)ₓ defects, because solvated OH⁻ requires that zeolite precursor units self-assemble around these ions. Fluoride ion exchanges with OH⁻, which forms tighter ion pairs with the cationic SDAs and leads to materials with lower densities of internal silanol defects. Common SDAs include cationic species (e.g., alkali, tetraalkylammonium, imidazolium, diquaternaryammonium, phosphonium, and diquarternaryphosponium; Scheme 1) that are charge balanced by an OH⁻ anion. Most studies that focus on the synthesis of hydrophobic materials use either fluoride-form SDAs or an equimolar amount of HF (to the OH⁻ form salt), which are equivalent when dissolved into an aqueous solution. FIG. 9, FIG. 11 and Table 1 show, however, that M-MFI-F(1) materials contain a smaller but still significant density of SiOH groups as an HF to TPAOH ratio of one decreases the density of SiOH functions by 4-8-fold. Greater quantities of HF (e.g., HF to TPAOH ratios equal to 1.5) further decreases the SiOH density to a value 30-100 times less than observed on samples synthesized in OH⁻ media. Materials created with these stoichiometric excesses of HF (i.e., x≥1.5) possess nearly undetectable densities of SiOH moieties.

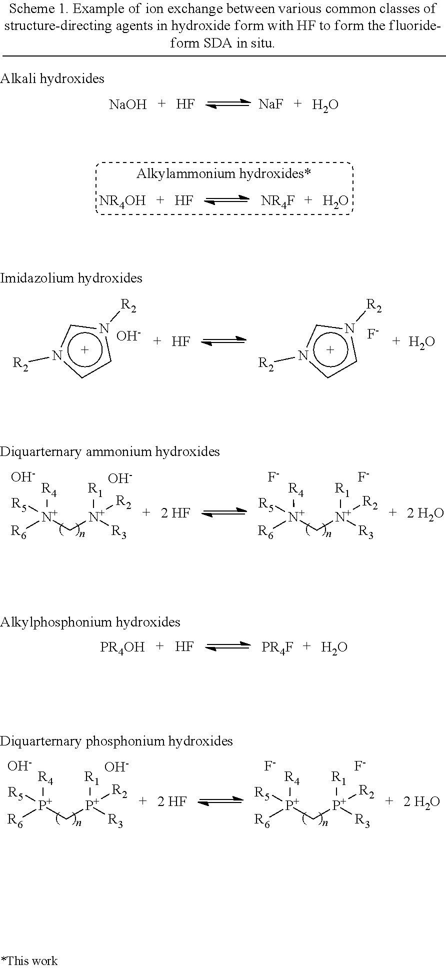

TPAOH ion exchanges with HF to form TPAF in situ; however, the ion exchange is reversible, and the concentrations of the species are dictated by equilibrium. The addition of excess HF to the synthesis gel biases the equilibrium between tetrapropylammonium hydroxide and tetrapropylammonium fluoride (Scheme 1) towards the products, which leads to fewer SiOH defects formed during hydrothermal synthesis. In the majority of studies on zeolite synthesis in fluoride media, hydrophobic materials are crystallized in synthesis gels that contain stoichiometric amounts of F⁻ and SDA. As such, this concept likely extends to other SDAs capable of ion exchange (see Scheme 1 for several examples), such that the HF:SDA ratio within the synthesis gel can be used to control the SiOH density for a variety of zeolite frameworks (e.g., CHA, MFI, BEA, MWW, CIT-5) that are synthesized hydrothermally using cationic SDAs. While the use of HF to form SDA-F complexes in situ is expected to be extended to a variety of SDAs, the equilibrium that describes SDA-F formation likely depends on the chemical properties (e.g., pKa) of the SDA, the pH of the synthesis gel, and the crystallization temperature.

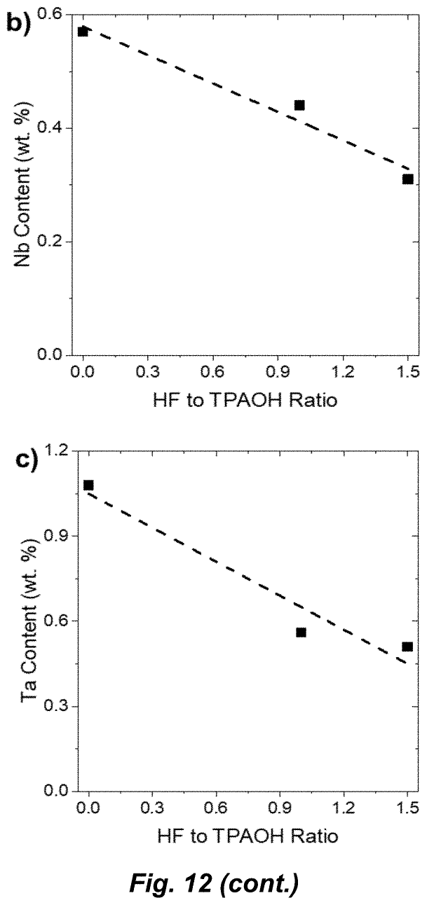

The extent of heteroatom incorporation into the MFI framework depends on the concentration of F⁻ ions within the synthesis solution. The synthesis gels for the Ti-, Nb-, and Ta-MFI-F(x) materials described in Table 1 contained amounts of the heteroatom precursor intended to yield materials with transition metal weight percentages of 0.3, 0.6, and 1.2, respectively. When these materials are synthesized in purely OH⁻ media (i.e., M-MFI-F(0)), more than 90% of the transition metal atoms within the synthesis gel incorporate into the recovered solids. The amount of metal incorporated, however, decreases monotonically as the concentration of F⁻ ions increases (Table 1; FIG. 12). For example, the percentages of Ti incorporated into Ti-MFI-F(0) and Ti-MFI-F(1.5) are 90 and 13%, respectively. In comparison, 95 and 52% of the Nb atoms are incorporated into Nb-MFI-F(0) and Nb-MFI-F(1.5) materials, respectively, while 90 and 43% of Ta atoms are incorporated into Ta-MFI-F(0) and Ti-MFI-F(1.5), respectively. These trends suggest that F⁻ ions may react with the transition metal precursors to form metal fluoride complexes (e.g., M(OH)ₓF_{y}; M=Ti, Nb, or Ta) that resist hydrolysis and condensation into the MFI framework. The strong dependence of the Ti incorporation efficiency on HF concentration, in comparison to Nb or Ta, prompted us to examine the effect of the HF and Ti precursor concentrations on Ti-MFI synthesis in detail and to characterize the supernatant following hydrothermal synthesis.

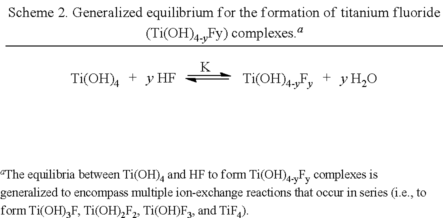

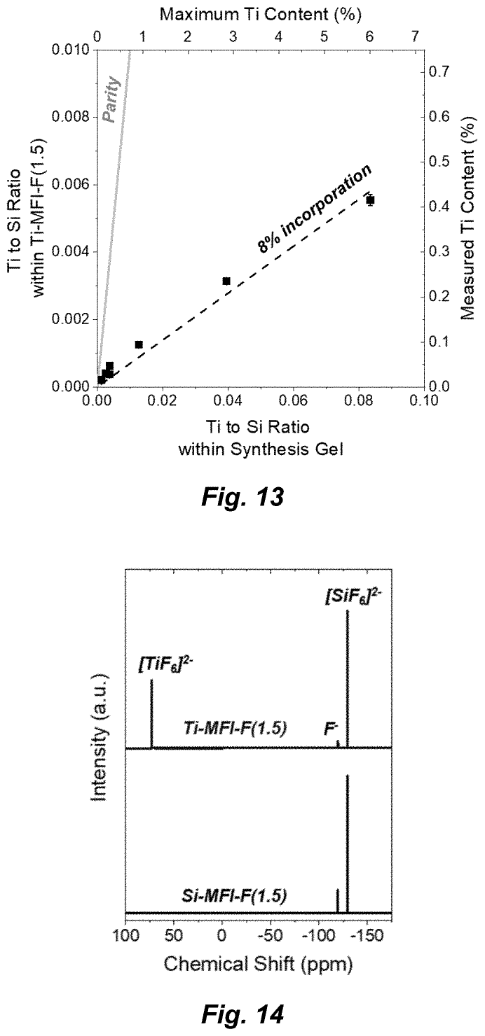

The number of Ti atoms incorporated into Ti-MFI-F(1.5) materials also depends on the concentration of the transition metal precursor within the synthesis gel. FIG. 13 shows that the measured Ti loading within Ti-MFI-F(1.5) increases linearly with Ti content in the synthesis gel. For all Ti-MFI-F(1.5), the measured Ti content in the recovered solids is ˜8% of the Ti content within the synthesis gel. During synthesis, Ti(OBu)₄ molecules hydrolyze to form Ti(OH)₄ species that condense during crystallization and are incorporated into the MFI framework. These Ti(OH)₄ species condense via reaction with HF to form stable titanium fluoride complexes (Ti(OH)_{4-y}F_{y}; y=1-4), which resist framework incorporation. Consequently, the constant ratio of the Ti content within the recovered solids to that in the original synthesis gel likely reflects the equilibrium to form Ti(OH)_{4-y}F_{y} species, shown in Scheme 2.

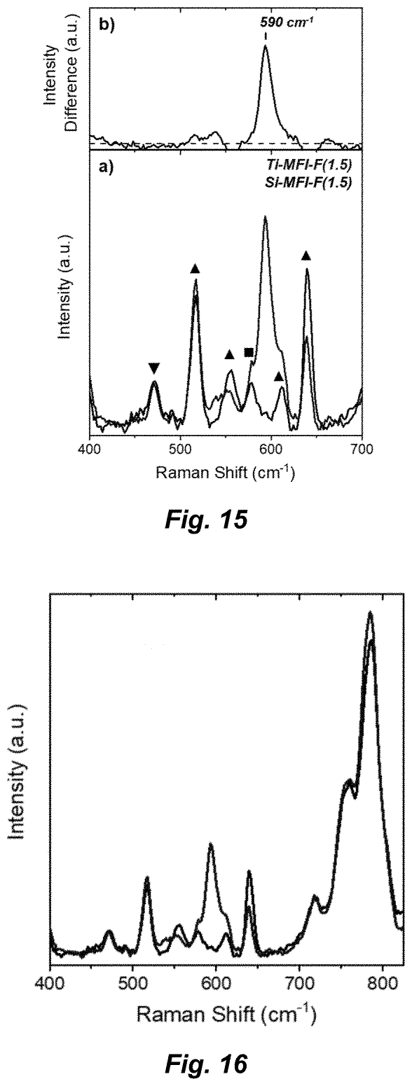

¹⁹F nuclear magnetic resonance (NMR) and Raman spectroscopy provides direct evidence for the formation of the Ti(OH)_{4-y}F_{y} complexes. FIG. 14 shows ¹⁹F NMR spectra of the supernatant from Si-MFI-F(1.5) and Ti-MFI-F(1.5) contain several features between 80 and 130 ppm. Both supernatants from Si- and Ti-containing syntheses possess ¹⁹F NMR features at −130 and −120 ppm, which correspond to solvated [SiF₆]²⁻ and F⁻ anions, respectively. The supernatant from Ti-MFI-F(1.5) possesses an additional feature at 80 ppm, which corresponds to solvated [TiF₆]²⁻ complexes. FIG. 15a shows Raman spectra of the supernatant from Si-MFI-F(1.5) and Ti-MFI-F(1.5) syntheses, which contain several significant vibrational features between 400-700 cm⁻¹. The feature at 470 cm⁻¹ corresponds to 5- and 6-membered ring zeolite precursor units, while the vibration at 570 cm⁻¹ is attributed to colloidal MFI particles. The remaining vibrational modes that are common to both Si- and Ti-MFI syntheses, at 510, 555, 605, and 640 cm⁻¹, are associated with the tetrapropylammonium cation.

FIG. 13b shows that the Raman difference spectrum between the supernatant from Ti-MFI-F(1.5) and Si-MFI-F(1.5) contains a single prominent feature at 590 cm⁻¹. Vibrational spectra of homogeneous Ti⁴⁺ organometallic (e.g., TiCp₂F₂) and halogeno (e.g., TiCl_{z}F_{4-z}; z=0-4) complexes possess v(Ti—F) modes at 568 cm⁻¹, or between 520-737 cm⁻¹, respectively. The feature at 590 cm⁻¹ (FIG. 15b) does not belong to Ti(OH)₄ complexes, which possess v(Ti—O) between 706-752 cm⁻¹ (FIG. 16 shows the Raman spectra in FIG. 13 with an extended abscissa). As such, the vibrational feature at 590 cm⁻¹ in FIG. 11 likely corresponds to v(Ti—F) of homogeneous Ti(OH)_{4-y}F_{y} complexes. These Raman data, in conjunction with ¹⁹F NMR spectra strongly suggest that the formation of soluble titanium fluoride complexes leads to lower efficiencies for the incorporation of transition metals into the zeolite framework.

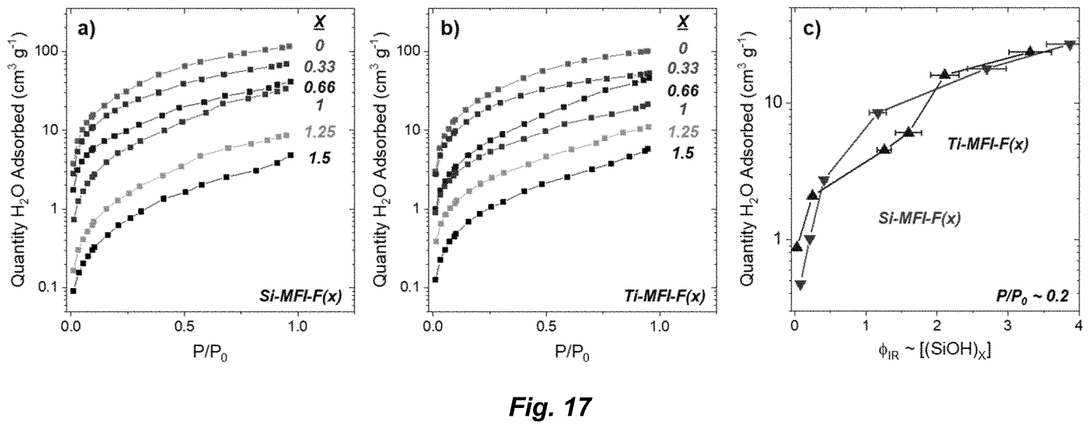

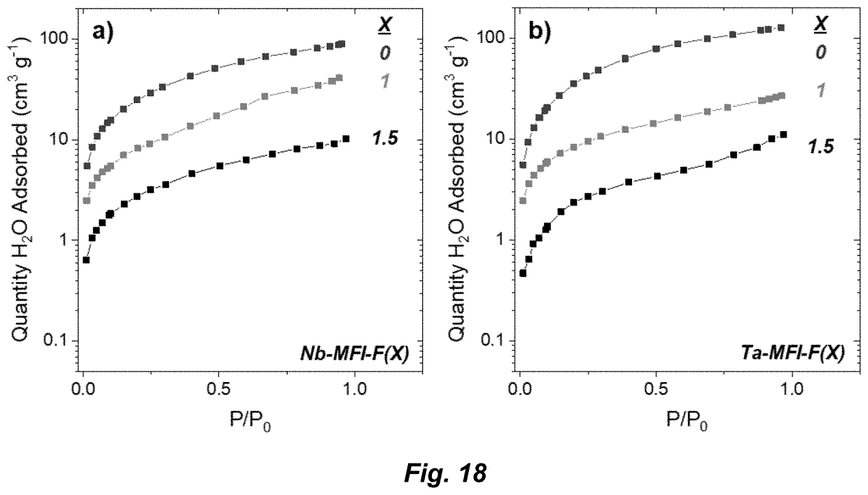

Water Sorption and Cluster Sizes Depends on Silanol Density and Heteroatom Identity. The presence and density of polar SiOH functions within a zeolite impacts the adsorption of molecules within the pores, which may have implications during catalysis or in separations. FIG. 17 shows H₂O vapor adsorption isotherms for Ti-MFI-F(x) and Si-MFI-F(x) materials at 293 K, and adsorption isotherms for Nb- and Ta-MFI-F(x) are shown in FIG. 18. H₂O adsorption within M-MFI-F(x) resembles a typical type I isotherm that is characteristic of adsorption within a microporous solid. FIG. 17a,b and FIG. 18 show that the quantity of H₂O adsorbed at any given P/P₀ increases monotonically with SiOH density regardless of the presence or identity of framework heteroatoms. For example, Si-MFI-F(0) (i.e., synthesized within OH⁻ media) adsorbs 7- and 100-times more H₂O than Si-MFI-F(1) and Si-MFI-F(1.5) across the entire range of P/P₀ (FIG. 14a). The uptakes of H₂O within M-MFI-F(0) are 10-100 times greater than within the corresponding M-MFI-F(1.5) materials (FIG. 17 and FIG. 18). These comparisons demonstrate the significant effect of SiOH density on the bulk volumetric uptake of H₂O.

FIG. 17c shows that the amounts of H₂O adsorbed within Si and Ti-MFI-F(x) are indistinguishable when these structures contain significant densities of SiOH (i.e., where x≤1). H₂O molecules bind exothermically (˜−33 kJ mol⁻¹) to monomeric, dimeric, and oligomeric H₂O clusters, which indicates that H₂O clusters form spontaneously within materials that contain significant densities of SiOH upon coordination of a single H₂O. In contrast, Si-MFI-F(x) that contain few SiOH (i.e., where x≥1.25) adsorbs significantly less H₂O than the corresponding Ti-MFI-F(x), which suggests that framework Ti atoms serve to nucleate and bind a non-negligible number of H₂O molecules.

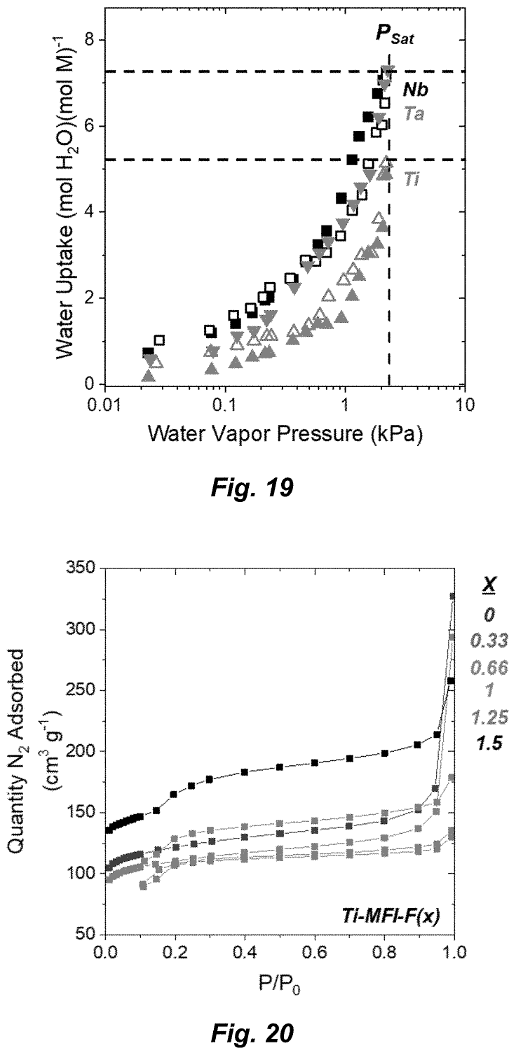

To examine the interactions between adsorbed H₂O molecules and framework metal atoms, we accounted for the contributions from SiOH functions by subtracting the adsorption isotherm of Si-MFI-F(x) from those of Ti-, Nb-, or Ta-MFI-F(x) (where x=1, 1.25, or 1.5). The particular M-MFI-F(x) in this analysis were chosen because their ϕ_{IR} values are within 0.05 of the corresponding Si-MFI-F(x), which was important to deconvolute H₂O adsorption to heteroatoms from adsorption onto SiOH defects. FIG. 19 shows the number of H₂O molecules adsorbed per metal atom within M-MFI-F(x) as a function of H₂O pressure. Importantly, H₂O adsorption isotherms normalized per Ti or Nb atom are indistinguishable for a given metal, which suggests that these data reflect H₂O adsorption solely to framework heteroatoms. For all M-MFI-F(x), the average number of H₂O molecules bound to framework M atoms increases monotonically as the pressure of H₂O increases from 0.02 to 2.3 kPa. At all H₂O vapor pressures, the uptake of H₂O at Nb or Ta atoms is greater than at Ti atoms, which suggests that H₂O binds more exothermically to Nb or Ta atoms than to Ti.

At equilibrium, the chemical potential of H₂O within the vapor phase equals that of H₂O bound to M atoms. Further, the chemical potential of H₂O within the liquid and vapor phases are equal at the saturation vapor pressure (Pₛₐₜ; 2.34 kPa, 293 K). Consequently, the number of H₂O atoms adsorbed at an M atom at the saturation pressure of H₂O represents the size of the solvent structure that would form when the zeolite is immersed within liquid H₂O. This reasoning, combined with result in FIG. 19, shows that Nb and Ta atoms stabilize approximately 7-8 H₂O molecules within aqueous media (i.e., at Pₛₐₜ). In comparison, recent work shows that Brønsted acid sites within H⁺—Al-MFI stabilize 8 H₂O molecules in liquid H₂O, within a structure that consists of a hydronium cation (H₃O⁺) surrounded by a 7-membered solvation shell. Nb and Ta atoms substituted within the framework of a zeolite exist as M(OSi)₄OH, which acts as a weak Brønsted acid as shown from vibrational spectra of adsorbed pyridine. The similarities in H₂O cluster size within Nb- and Ta-MFI-F(1.5) and those within H⁺—Al-MFI suggest that 7-8 H₂O molecules solvate protic sites within the MFI framework, regardless of the identity of the associated framework heteroatom.

In contrast to Nb, Ta, and Al atoms, framework-substituted Ti atoms exist as Ti(OSi)₄ and are Lewis acidic and not Brønsted acidic. FIG. 19 shows that Ti atoms would stabilize ˜5 H₂O molecules within liquid H₂O (i.e., at Pₛₐₜ). Recent work with ab initio molecular dynamics simulations showed that interactions between H₂O and Lewis acidic Sn sites (i.e., Sn(OSi)₄ and Si(OSi)₃OH) within Sn-BEA zeolites stabilize small H₂O clusters that comprise 5-6 H₂O molecules. Notably, the binding energy of H₂O to a framework Sn atom is greater than to a Ti atom (i.e., −32 versus −12 kJ mol for Sn- and Ti-BEA, respectively). As such, the size of the H₂O structures that form at Lewis acid sites appears to be weakly dependent on the size of the surrounding microporous cavity (MFI and BEA have average pore diameters of 0.55 and 0.65 nm, respectively) and the binding energy of H₂O to the Lewis acid site. Collectively, these data and interpretations suggest that H₂O structures formed at Lewis acid sites (˜5 H₂O per Lewis acidic M atom) are distinct from those that form at Brønsted acid sites (˜7-8 H₂O per H⁺), which may have implications in the performance of a zeolite as a catalyst or adsorbent.

The structure of H₂O molecules within a zeolite pore greatly influences the thermodynamic stability of surface intermediates, which drastically affects catalysis. Rates of alkene epoxidation over Ti-BEA increase by a factor of 100 between nearly defect-free materials and Ti-BEA that contain ˜5 (SiOH)₄ per unit cell. Ti-BEA that contain high densities of (SiOH)₄ nucleate H₂O structures near Ti active sites. These H₂O structures reorganize during catalysis and contribute to large increases in the excess entropy that ultimately increase rates of 1-octene epoxidation. In contrast, SiOH-rich domains within Ti- and Sn-BEA inhibit aqueous-phase glucose isomerization. Ti- and Sn-BEA that contain significant SiOH densities stabilize hydrogen-bonded H₂O networks; in contrast, hydrophobic materials contain gas-like molecular H₂O structures. The exclusion and reorganization of these H₂O molecules contribute to changes in the apparent free energies of activation, which lead to decreased rates of glucose isomerization in hydrophilic catalysts.

In the context of adsorption, both hydrophilic and hydrophobic H-ZSM-5 adsorb comparable amounts of ethanol, while hydrophilic materials adsorb 4-times more H₂O than within hydrophobic pores, which shows the potential for selective separations within aqueous alcohol mixtures. Recently, Gould et al. constructed a Born-Haber thermochemical cycle to assess the effects of confinement and solvation on pyridine adsorption in Brønsted acid zeotypes (MFI, BEA, FAU, SBA-15, MCM-41), and this analysis showed that the apparent free energies for an adsorption process depend strongly on the structure of the solvating molecules. We have recently taken a similar approach to determine the significance of individual types of interactions on free energy landscapes for alkene epoxidations in liquid-filled pores of Ti-silicates. These findings demonstrate that distinct contributions to the free energy of activation by solvent restructuring and inner-sphere interactions among reactive surface species lead to changes in epoxidation rates in excess of 1000-fold. These studies, a portion of the literature, exemplify how the structure of solvent molecules within microporous solids can lead to large changes in catalytic rates or separation selectivities.

The synthesis approach described here provides an unusual degree of control over the density of SiOH groups within Si-MFI and transition metal substituted MFI catalysts. Consequently, this work offers the means to manipulate the number and structure of H₂O molecules (and likely other solvent molecules) within the pores of zeolite catalysts. This synthetic control is significant, because these intermolecular interactions impact the thermodynamic stability of surface intermediates coordinated to active sites and drastically affect rates and selectivities for catalytic reactions. The results presented here show that the HF:SDA ratio within the synthesis gel can be varied to control the density of SiOH groups within recovered MFI materials. The density of SiOH groups, in turn, influences the quantity, structure, and stability of H₂O molecules within the pores and in the proximity of catalytic active sites. Previous investigations of numerous reactions catalyzed within the confines of liquid-filled zeolite pores demonstrate that turnover rates depend on the presence of proximate H₂O molecules, because intrapore solvent molecules (water or otherwise) introduce excess thermodynamic contributions and mediate long-range interactions between reactive intermediates and the extended structure of the pore. This simple method can likely be extended to other zeolite frameworks and heteroatom identities, which will enable researchers to access materials with tunable properties to study the effects of complex interactions at the solid-liquid interface on catalysis and separations processes.

### CONCLUSIONS

The density of polar SiOH functions within siliceous and heteroatom-substituted MFI zeolites (M=Ti, Nb, and Ta) can be controlled by tuning the ratio of HF to TPAOH (from 0 to 2) within the synthesis gel. The relative densities of SiOH groups, characterized by infrared spectroscopy, decreases linearly with the HF:TPAOH ratio and approaches zero at an HF:TPAOH ratio of 1.5. HF and TPAOH ion exchange in situ to form TPAF, which does not lead to the formation of anionic vacancy defects in the final zeolite. Consequently, the use of HF in excess of TPAOH is necessary to produce materials without SiOH defects, because this ion exchange is dictated by equilibrium. Metal-fluoride complexes (e.g., Ti(OH)ₓF_{y}) formed by the reaction of Ti(OH)₄ with HF resist framework incorporation and lead to significant fractions of metal ions (e.g., Ti⁴⁺) that do not end up in the final zeolite. The low amounts of metal incorporation, however, can be mitigated by using a greater amount of metal precursor, as the metal loading in the recovered materials depends linearly on the concentration of the metal precursor within the synthesis gel.

Vapor-phase H₂O adsorption shows that M-MFI materials synthesized with a HF:TPAOH ratio of 1.5 adsorb 10-100 times less H₂O than those synthesized in the absence of HF, which far exceeds the 4-fold difference reported in conventional hydrophilic and hydrophobic MFI zeolites. Comparisons of H₂O adsorption within defect-free materials reveal that Ti and Nb atoms selectively stabilize H₂O clusters that are 5 and 7-8 H₂O molecules in size, respectively. Nb and Ta atoms exist with a pendant hydroxyl (M-OH), which suggests that these adsorption sites behave similarly to Brønsted acids. In contrast, Lewis acid sites nucleate structurally distinct H₂O structures that do not appear to depend strongly on the identity of the heteroatom (Ti versus Sn) or size of the surrounding micropore (MFI versus BEA). The formation of specific solvent structures at heteroatoms within zeolites may have significant implications in catalysis and adsorption processes, which are on-going investigations within our group. Collectively, this work presents a robust synthetic method for producing heteroatom substituted zeolites with precise control over the density of SiOH groups.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1. Materials and Methods

Synthesis of Metal-Substituted Zeolites. Titanium butoxide (TiBO; Sigma-Aldrich, 97%, reagent grade), niobium ethoxide (NbEO; Sigma-Aldrich, 99.95%, trace metals basis), tantalum ethoxide (TaEO; Sigma-Aldrich, 99.98%, trace metals basis), Titanium isopropoxide (TiiPO, Sigma-Aldrich, 99.99%) tetraethylorthosilicate (TEOS, Sigma-Aldrich, 98%, reagent grade), tetrapropylammonium hydroxide (TPAOH; Sachem, 40% in H₂O), trimethyladamantylammonium hydroxide (TMAdaOH, Sachem, 25% in H₂O), tetraethylammonium hydroxide (TEAOH, Sachem, 40% in H₂O), potassium carbonate (K₂CO₃, Sigma-Aldrich, 99%) hydrofluoric acid (HF; Sigma-Aldrich, 48-50% in H₂O), and H₂O (18.2 MΩ·cm) were used as received.

Metal-substituted MFI (M-MFI; M=Si, Ti, Nb, or Ta) was synthesized hydrothermally in either hydroxide or fluoride media. A desired amount of the metal precursor (i.e., TiBO, NbEO, or TaEO) was dissolved in 27.7 g of TEOS in a polypropylene bottle with a screw cap to form a homogeneous solution that was subsequently cooled to 273 K. Separately, a mixture of 28.7 g of TPAOH and 50.5 g of H₂O was cooled to 273 K and was added slowly (over a period of ˜1 min) to the TEOS solution, which yielded a biphasic mixture. This solution was warmed to 298 K and stirred for 12 h to produce a clear homogeneous solution, which indicates successful hydrolysis of the metal precursor and TEOS. Solutions that are cloudy contain metal oxide nanoparticles that preclude the incorporation of the metal into the zeolite framework. In these cases, the solution was discarded, and the synthesis was initiated with fresh reagents. The cover was then removed to completely evaporate the alcohol (e.g., ethanol, butanol) formed through hydrolysis of TEOS and the metal alkoxides. To ensure the complete evaporation of the alcohols, an additional 15 wt. % of the calculated mass of the alcohols was evaporated over the course of 24-48 h and deionized H₂O was added to make up for the excess liquid evaporated. This solution was then loaded into a Teflon-lined stainless-steel autoclave (Parr instruments, 125 cm³).

While in the Teflon liner, a desired amount of HF (warning: HE is extremely dangerous and should be handled very carefully) was added to the synthesis gel and stirred manually with a polypropylene spatula for ˜10 seconds prior to gelation. Notably, the addition of at least an equimolar amount of HF, with respect to TPAOH, increases the viscosity of the synthesis gel significantly. These steps yield a gel with the approximate composition of 1 Si:a M:0.43 TPAOH:b HF:28.3 H₂O, where a and b depend on the amount of metal precursor and HF used, respectively. A small amount of Ti- or Si-MFI seeds (5% by mass relative to SiO₂) from a previous synthesis in OH⁻ media were added to promote the crystallization of MFI. These autoclaves were then heated to 443 K while rotating (30 rpm) in a convection oven (Yamato, DKN602C) for a desired amount of time (72-504 h). The resulting solids were recovered by centrifugation, washed with H₂O, and dried for 16 h at 373 K. The dried solids were then heated in flowing air (100 cm³ min⁻¹; Airgas, Ultra-zero grade) to 823 K at 1 K min⁻¹ and held for 10 h to produce M-MFI materials that were bleached white in appearance. Typical zeolite yields were between 75-95%, by mass of SiO₂. Infrequently, the recovered solids appear off-white or yellow-brown; however, subsequent oxidative treatment in flowing air removes the residual organics likely responsible for these colors.

Titanium-substituted MWW zeolites were synthesized hydrothermally in either hydroxide or fluoride media. Approximately 7.55 mF of TMAdaOH (25% in H₂O) was mixed with 22.5 g of H₂O. This solution was subsequently divided into two equal parts separated into two polypropylene bottles affixed with screw caps, which are referred to as solutions “a” and “β.” Approximately 380 mg of TiBO was added to solution α, while 1.05 g of K₂CO₃ was added to solution β. Both solution α and β were then stirred for 30 min at ambient temperature and pressure. After stirring for 30 min, 3.22 g of fumed silica (Cabot corp.) was added to each solution, which were then stirred for an additional 1 h. Solution α was then added to solution p, which were stirred for 1.5 h. These solutions were then transferred to the Teflon liners and an appropriate amount of HF (relative to the amount of TMAdaOH) was added and stirred manually for 30 s. Ti-MWW seeds from a previous synthesis were added (2 wt. % relative to SiO₂) and the autoclaves were sealed and heated to 423 K in a static oven for approximately 11 days. The resulting solids were recovered by centrifugation, washed with H₂O, washed with 2 M HNO₃ (20 cm³ g⁻¹_{Solid}) and dried for 16 h at 373 K. The dried solids were then heated in flowing air (100 cm³ min⁻¹; Airgas, Ultra-zero grade) to 823 K at 1 K min⁻¹ and held for 10 h to produce Ti-MWW materials that were bleached white in appearance.

Titanium-substituted BEA zeolites were synthesized hydrothermally in fluoride media. Approximately 36.25 mL of TEAOH (40% in H₂O) was added to 24.52 g of H₂O in a sealed polypropylene bottle to form a clear homogenous solution. To this solution 0.309 mL of TiiPO was added and the solution was stirred for 0.5 h. Next, 39.87 mL of TEOS was added to this solution, which initially formed a biphastic mixture. This biphasic mixture was stirred for 16 h to produce a clear homogeneous solution, which suggests that TEOS molecules were hydrolyzed to form Ti(OH)₄ equivalents. The cap was then removed to the polypropylene bottle and the solution was stirred for an additional 48-72 h to completely evaporate the alcohol (e.g., ethanol, butanol) formed through hydrolysis of TEOS and the TiiPO. To ensure the complete evaporation of the alcohols, an additional 15 wt. % of the calculated mass of the alcohols was evaporated and deionized H₂O was added to make up for the excess liquid evaporated. This solution was then loaded into the Teflon liners of the autoclaves. A desired amount of HF (relative to the TEAOH) was added to the solution and the mixture was stirred manually with a plastic spatula for approximately 30 seconds. Ti-BEA seeds (5 wt. % relative to SiO₂) from a previous synthesis were added. These autoclaves were then heated to 443 K while rotating (30 rpm) in a convection oven for a desired amount of time (25-35 days). The resulting solids were recovered by centrifugation, washed with H₂O, and dried for 16 h at 373 K. The dried solids were then heated in flowing air (100 cm³ min⁻¹; Airgas, Ultra-zero grade) to 823 K at 1 K min⁻¹ and held for 10 h to produce Ti-BEA materials that were bleached white in appearance.

Characterization of Zeolites. The metal contents of all M-MFI were determined using energy dispersive X-ray fluorescence (EDXRF). Finely-ground M-MFI samples were loaded into a polypropylene sample holder (2.54 cm aperture), which was sealed with an ultralene film. These samples were loaded into a spectrometer (Shimadzu, EDX-7000) whose sample chamber was purged with He (Airgas, Ultra-zero grade) prior to measurement. Spectra were obtained between 0 and 30 keV (100 scans), and the relative intensities of the element-specific fluorescence features and their associated calibration factors were used to determine the percent, by mass, of each element within the sample.

The crystallinity of the MFI framework was measured through X-ray diffraction. Samples were loaded onto a polypropylene holder, and diffractograms were collected on an X-ray diffractometer (Bruker, D8) with Cu Kα radiation (0.15418 nm) under ambient conditions.

The presence of highly-disperse M atoms (and absence of bulk or oligomeric MOₓ domains) for M-MFI samples was inferred by the band edge energies, which were measured using diffuse reflectance UV-vis spectroscopy. Total reflectance spectra were measured under ambient conditions using a diffuse-reflectance accessory (Harrick, Cricket) with a UV-Vis-NIR spectrophotometer (Agilent, CARY 5). Prior to measurement, samples were intimately mixed with magnesium oxide (MgO; Sigma-Aldrich, 99.995%) in a 1:10 ratio by mass.

The morphology of M-MFI samples was characterized using scanning electron microscopy (SEM). Samples were intimately ground and dispersed on double-sided carbon tape, which was attached to an SEM holder. Samples were coated with an Au—Pd alloy using a sputter coater (Emitech, K575) to inhibit surface charging. This metal sample holder was loaded onto a microscope (JEOL, 6060) and was degassed prior to imaging. Micrographs were obtained using an accelerating voltage of 10 kV and a working distance of 10 mm.

The incorporation of heteroatoms into the MFI framework was inferred using attenuated total reflectance-infrared spectroscopy. Samples were pressed onto a diamond internal reflection element of an infrared spectrometer (Bruker, Alpha) and spectra (8 scans, 2 cm⁻¹ resolution) were recorded at ambient conditions.

¹⁹F nuclear magnetic resonance (NMR) spectra were collected on the supernatant from Si- and Ti-MFI-F(1.5) syntheses to detect the formation of Ti—F complexes. ¹⁹F NMR spectra were collected on a spectrometer (Varian, 600 NB) operating at 564 MHz. All spectra were referenced to CFCl₃ (1% CFCl₃ in CDCl₃), which has a ¹⁹F chemical shift of 0 ppm.

Infrared (IR) spectra of the dehydrated zeolites were used to quantify the relative density of silanol groups within this series of materials. Vibrational spectra were obtained using a custom-built temperature-controlled transmission cell coupled to a Fourier-transform IR spectrometer (Bruker, Vertex 70) with a liquid N₂-cooled HgCdTe detector. Self-supporting catalyst wafers (˜45 mg) were loaded into the transmission cell, which was configured with CaF₂ windows and connected to a gas manifold. All materials were first heated to 573 K at 10 K min⁻¹ and held for >2 h in flowing He (50 cm³ min⁻¹) to desorb water and volatile compounds. IR spectra (128 scans, 1 cm⁻¹) of the dehydrated zeolite pellets were then recorded at 573 K, and the corresponding background spectra were obtained with the empty cell at identical conditions.

Raman spectra of the supernatant recovered after the hydrothermal synthesis of Ti- and Si-MFI-F(1.5) samples, where 1.5 represents the HF to TPAOH ratio, were used to detect the formation of soluble titanium fluoride complexes that resist incorporation into the zeolite framework during hydrothermal synthesis. The supernatant from these syntheses was recovered by centrifugation. A portion of this liquid (20 cm³) was dried at 353 K under flowing air (100 cm³ min⁻¹) for 10 h to yield a thick gel. These gels were spread on glass microscope slides (VWR) and Raman spectra were collected on a spectrometer (Renishaw, inVia) equipped with a 532 nm laser. Spectra were obtained with line-scan mode using a long 50× objective such that the power density was approximately 0.4 mW μm⁻².

Gas-phase adsorption isotherms were collected on a volumetric adsorption instrument (Micromeritics, 3Flex). M-MFI samples were pelletized and sieved to retain particles greater than 180 μm in diameter. These samples were degassed by heating under vacuum (<7 10⁻⁴ Pa, 673 K) for 6 h prior to adsorption measurements. Vapor-phase H₂O adsorption measurements were conducted at room temperature (293±1 K), while N₂ adsorption was conducted at 77 K (FIG. 20). The H₂O used was degassed via one freeze-pump-thaw cycle prior to measurements.

Relationship Between Crystallization Rates and Heteroatom Identity. Empirically, the crystallization time increases with the radius of the metal cation incorporated into the MFI framework (e.g., Si⁴⁺ (40 μm), Ti⁴⁺ (56 μm), Nb⁵⁺ (78 μm), and Ta⁵⁺ (78 μm)) for M-zeolite syntheses. This phenomenon may reflect an expansion of the unit-cell caused by incorporation of the heteroatoms, which in turn, increases the energetic barrier for crystallization.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A zeolite composition that is siliceous or comprises a transition metal incorporated into the framework of the zeolite, and comprises a density of silanol groups characterized by infrared spectroscopy as a ratio of the area of O—H vibrations to Si—O—Si overtone vibrations (A_{O—H}/A_{Si—O—Si}), wherein the silanol density (Φ) is about 0.4 or less when the zeolite is siliceous, Φ is about 1 or less when the zeolite comprises titanium (Ti), or Φ is about 2.5 or less when the zeolite comprises niobium (Nb) or tantalum (Ta).

2. The zeolite of claim 1 wherein the framework type of the zeolite is Socony Mobil-5 (MFI), Beta (BEA), or MWW.

3. The zeolite of claim 1 wherein the zeolite is siliceous and the silanol density is about 0.01 to about 0.3.

4. The zeolite of claim 1 wherein the zeolite comprises Ti, Nb, or Ta and the silanol density is about 0.01 to about 0.5.

5. The zeolite of claim 1 wherein the zeolite comprises Ti, Nb, or Ta and the silanol density is about 0.01 to about 0.4.

6. The zeolite of claim 1 wherein the zeolite has no measurable silanol (SiOH) defects, or no measurable SiOH contributing to H₂O adsorption.

7. A zeolite composition comprising a metal or metalloid incorporated into the framework of the zeolite and a density of silanol groups characterized by infrared spectroscopy as a ratio of the area of O—H vibrations to Si—O—Si overtone vibrations (A_{O—H}/A_{Si—O—Si}), wherein the silanol density (Φ) is about 0.4 or less; or
the hydrophobic zeolite composition comprising a metal or metalloid that is not Ti, Nb, or Ta, and the silanol density is about 3 or less.

8. The zeolite of claim 7 wherein the zeolite comprises Al, B, Ga, Ge, Hf, Sn, or Zr and the silanol density is about is about 3 or less.

9. The zeolite of claim 7 wherein the zeolite comprises Al, B, Ga, Ge, Hf, Sn, or Zr and the silanol density is about 0.01 to about 0.5.

10. A method for forming a hydrophobic zeolite comprising:
contacting hydrofluoric acid (HF) and a zeolite synthesis gel comprising a hydroxylated structure directing agent (SDA-OH);
wherein the HF and SDA-OH have a molar ratio (moles HF/moles SDA-OH) of greater than about 1, or greater than 0.1 and less than 1.

11. The method of claim 10 wherein the molar ratio is about 1.1 to about 2.0, or the molar ratio is about 1.25 to about 1.5.

12. The method of claim 10 wherein the formed hydrophobic zeolite comprises a density of silanol groups characterized by infrared spectroscopy as a ratio of the area of O—H vibrations to Si—O—Si overtone vibrations (A_{O—H}/A_{Si—O—Si}), wherein the silanol density (Φ) is about 3 or less.

13. The method of claim 10 wherein the SDA-OH is an alkali hydroxide, quaternary ammonium hydroxide, quaternary imidazolium hydroxide, diquaternary ammonium hydroxide, quaternary phosphonium hydroxide, diquaternary phosphonium hydroxide, or combination thereof.

14. The method of claim 10 wherein the SDA-OH is tetrapropylammonium hydroxide.

15. The method of claim 10 wherein the zeolite synthesis gel comprises a hydrolyzed tetraalkylorthosilicate, and optionally a hydrolyzed metal alkoxide or hydrolyzed metal halide.

16. The method of claim 10 wherein the zeolite synthesis gel comprises a hydrolyzed tetraalkylorthosilicate and a hydrolyzed metal alkoxide.

17. The method of claim 16 wherein the metal of the hydrolyzed metal alkoxide is titanium, niobium, or tantalum.

18. The method of claim 10 wherein the method includes forming the zeolite synthesis gel comprising:
contacting SDA-OH and a composition comprising a tetraalkylorthosilicate or fumed silica and optionally a transition metal alkoxide or metal halide;
wherein SDA-OH is a quaternary tetraalkylammonium hydroxide.

19. The method of claim 10 wherein the hydrophobic zeolite is formed under suitable hydrothermal synthesis conditions.

20. The method of claim 19 wherein the suitable hydrothermal synthesis conditions comprises seeding with a suitable zeolite.

21. The method of claim 10 wherein the formed hydrophobic zeolite has a Socony Mobil-5 (MFI), Beta (BEA), or MWW framework type.
